(19) United States
(12) Patent Application Publication
(10) Pub. No.: US 2026/0329137 A1
(43) Pub. Date: Oct. 22, 2026

(54) LIGHTING DEVICE

(71) Applicant: Japan Display Inc., Tokyo (JP)

(72) Inventors: Tae KUROKAWA, Tokyo (JP); Takeo KOITO, Tokyo (JP); Kojiro IKEDA, Tokyo (JP)

(21) Appl. No.: 19/529,313

(22) Filed: Feb. 4, 2026

Related U.S. Application Data
(63) Continuation of application No. PCT/JP2024/028441, filed on Aug. 8, 2024.

(30) Foreign Application Priority Data
Aug. 28, 2023 (JP) 2023-137842

(51) Int. Cl. G02F 1/1343; F21V 9/40

(52) U.S. Cl. CPC G02F 1/134309; F21V 9/40

(57) ABSTRACT

A lighting device in an embodiment according to the present invention includes a liquid crystal light control element comprising a plurality of liquid crystal panels, wherein the plurality of liquid crystal panels is stacked; and a housing accommodating a light source, the housing having a light emission opening and an external appearance capable of identifying a reference direction. The liquid crystal light control element is disposed overlapping the light emission opening. When the housing is arranged with the reference direction facing a wall surface, in at least one liquid crystal panel among the plurality of liquid crystal panels, an extending direction of the first strip electrode and the second strip electrode and an extending direction of the third strip electrode and the fourth strip electrode intersect a normal direction of the wall surface.

### CROSS-REFERENCE TO RELATED APPLICATIONS

This application is a Continuation of International Patent Application No. PCT/JP2024/028441, filed on Aug. 8, 2024, which claims the benefit of priority to Japanese Patent Application No. 2023-137842, filed on Aug. 28, 2023, the entire contents of which are incorporated herein by reference.

### FIELD

An embodiment of the present invention relates to a lighting device that controls a light distribution direction of light emitted from a light source by utilizing an electro-optical effect of a liquid crystal.

### BACKGROUND

A technology has been developed that controls the spread of illumination light by utilizing a characteristic in which a refractive index of a liquid crystal changes according to an applied voltage (refer to, for example, International Patent Publication No. WO2022/176684 and International Patent Publication No. WO 2022/202299).

Since the liquid crystal light control device disclosed as prior art is capable of distributing light emitted from a light source into a linear shape or a cross shape on an irradiation surface, there is a need for the development of products with higher added value.

### SUMMARY

A lighting device in an embodiment according to the present invention includes a liquid crystal light control element comprising a plurality of liquid crystal panels, wherein the plurality of liquid crystal panels is stacked; and a housing accommodating a light source, the housing having a light emission opening and an external appearance capable of identifying a reference direction. Each of the plurality of liquid crystal panels includes a first substrate; a second substrate opposing the first substrate; a liquid crystal layer between the first substrate and the second substrate; a first strip electrode extending in a first direction and a second strip electrode arranged parallel to the first strip electrode provided on the first substrate; and a third strip electrode extending in a second direction intersecting the first direction and a fourth strip electrode adjacent to the third strip electrode, provided on the second substrate. The liquid crystal light control element is disposed overlapping the light emission opening. When the housing is arranged with the reference direction facing a wall surface, in at least one liquid crystal panel among the plurality of liquid crystal panels, an extending direction of the first strip electrode and the second strip electrode and an extending direction of the third strip electrode and the fourth strip electrode intersect a normal direction of the wall surface.

### BRIEF DESCRIPTION OF DRAWINGS

FIG. 1 is a schematic view showing an outline of a lighting device according to an embodiment of the present invention.

FIG. 2 is a perspective view of a liquid crystal panel constituting a liquid crystal light control element used in the lighting device according to an embodiment of the present invention.

FIG. 3A is a plan view of electrodes of the liquid crystal panel constituting the liquid crystal light control element used in the lighting device according to an embodiment of the present invention.

FIG. 3B is a plan view of electrodes of the liquid crystal panel constituting the liquid crystal light control element used in the lighting device according to an embodiment of the present invention.

FIG. 4A is a schematic view showing an alignment state of liquid crystal molecules when a voltage is applied to the liquid crystal panel constituting the liquid crystal light control element used in the lighting device according to an embodiment of the present invention.

FIG. 4B is a schematic view showing an alignment state of liquid crystal molecules when a voltage is applied to the liquid crystal panel constituting the liquid crystal light control element used in the lighting device according to an embodiment of the present invention.

FIG. 5 is a diagram illustrating an operation of the liquid crystal light control element used in the lighting device according to an embodiment of the present invention.

FIG. 6 is a diagram showing a configuration and a diffusion state of the liquid crystal light control element used in the lighting device according to an embodiment of the present invention.

FIG. 7 is a top view of a housing constituting the lighting device according to an embodiment of the present invention.

FIG. 8 is a top view of a housing constituting the lighting device according to an embodiment of the present invention.

FIG. 9 is a top view of a housing constituting the lighting device according to an embodiment of the present invention.

FIG. 10 is a top view of a housing constituting the lighting device according to an embodiment of the present invention.

FIG. 11 is a top view of a housing constituting the lighting device according to an embodiment of the present invention.

FIG. 12 is a diagram showing a configuration of the liquid crystal light control element used in the lighting device according to an embodiment of the present invention.

FIG. 13 is a diagram showing a light distribution pattern of the lighting device obtained by the liquid crystal light control element shown in FIG. 12.

FIG. 14 is a diagram showing a configuration of the liquid crystal light control element used in the lighting device according to an embodiment of the present invention.

FIG. 15A is a diagram showing a light distribution pattern of the lighting device obtained by the liquid crystal light control element shown in FIG. 14.

FIG. 15B is a diagram showing a light distribution pattern of the lighting device obtained by the liquid crystal light control element shown in FIG. 14.

FIG. 16 is a diagram showing a configuration of the liquid crystal light control element used in the lighting device according to an embodiment of the present invention.

FIG. 17 is a diagram showing a light distribution pattern of the lighting device obtained by the liquid crystal light control element shown in FIG. 16.

FIG. 18 is a diagram showing a configuration of the liquid crystal light control element used in the lighting device according to an embodiment of the present invention.

FIG. 19 is a diagram showing a light distribution pattern of the lighting device obtained by the liquid crystal light control element shown in FIG. 18.

FIG. 20 is a diagram showing the configuration of the liquid crystal light control element used in the lighting device according to an embodiment of the present invention.

FIG. 21 is a diagram showing a light distribution pattern of the lighting device obtained by the liquid crystal light control element shown in FIG. 20.

### DESCRIPTION OF EMBODIMENTS

Hereinafter, embodiments of the present invention will be described with reference to the drawings and the like. However, the present invention can be implemented in many different forms and should not be construed as being limited to the description of the embodiments exemplified below. Although the drawings may schematically represent the width, thickness, shape, and the like of each part compared to the actual form in order to clarify the explanation, they are merely examples and do not limit the interpretation of the present invention. In addition, in the present specification and each drawing, the same reference numerals (or numerals followed by A, B, etc.) are applied to elements similar to those described above with reference to the previously described drawings, and detailed descriptions thereof may be omitted as appropriate. The terms “first” and second” appended to each element are convenient terms used to distinguish them and have no further meaning except as otherwise explained.

As used herein, where a member or region is “on” (or “below”) another member or region, this includes cases where it is not only directly on (or directly below) the other member or region but also above (or below) the other member or region, unless otherwise specified. That is, it also includes the case where another component is included in between, above (or below) the other member or region.

In the present specification, the term “light distribution” refers to, in accordance with its ordinary meaning, a spread of light emitted from a light source, that is, a luminous intensity (light intensity) distribution with respect to each direction, and “controlling light distribution” refers to intentionally controlling the spread of light emitted from a light source.

In the present specification, the term “optical rotation” refers to a phenomenon in which a polarization axis of a linearly polarized light component is rotated when the component passes through a liquid crystal layer.

In the present specification, the “alignment direction” of an alignment film refers to a direction in which liquid crystal molecules are aligned when a treatment for imparting an alignment anchoring force (for example, a rubbing treatment) is performed on the alignment film to align the liquid crystal molecules on the alignment film. When the treatment performed on the alignment film is a rubbing treatment, the alignment direction of the alignment film is usually a rubbing direction.

In the present specification, the “extending direction” of a strip electrode refers to a direction in which a long side of a pattern having a short side (width) and the long side (length) extends when the strip electrode is viewed in a plan view.

### 1. Outline of Lighting Device

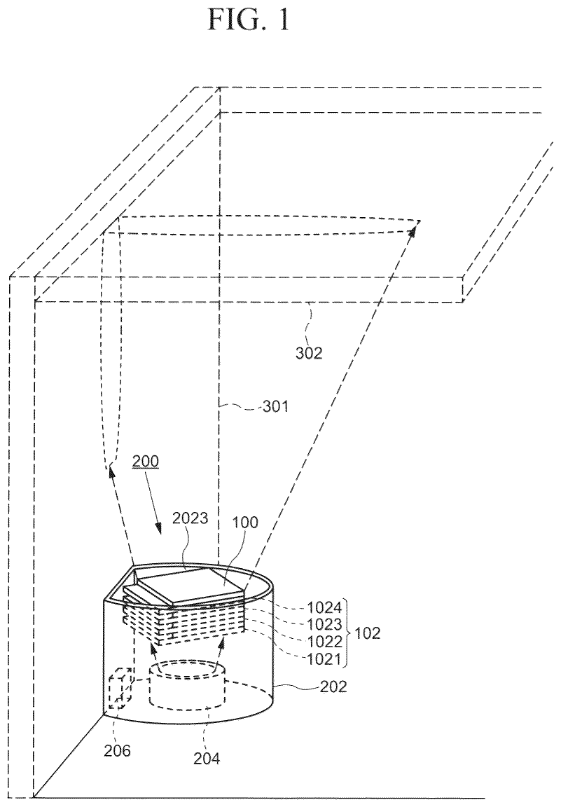

FIG. 1 is a schematic view showing an outline of a lighting device 200 according to an embodiment of the present invention. The lighting device 200 includes a light source 204, a liquid crystal light control element 100 that distributes light emitted from the light source 204, and a housing 202 accommodating these members. The housing 202 has a light emission opening 2023, and the light emitted from the light source 204 is emitted through the light emission opening 2023. The lighting device 200 includes a control circuit 206 that drives the liquid crystal light control element 100. The control circuit 206 may be disposed inside the housing 202 or may be disposed outside the housing 202.

When the lighting device 200 is used mainly for indirect lighting applications, the light emission opening 2023 is provided at an upper portion of the housing 202 such that the light from the light source 204 is emitted upward. For example, the light emission opening 2023 is provided on a top surface of the housing 202. Although the opening shape of the light emission opening 2023 is arbitrary, it is preferable that the light emission opening 2023 has a shape that exposes the liquid crystal light control element 100 and prevents the light emitted from the light source 204 from leaking from other regions. The light emission opening 2023 may be formed by a through hole that exposes the liquid crystal light control element 100. A transparent or colored cover material may be attached to the light emission opening 2023 to cover the liquid crystal light control element 100.

The liquid crystal light control element 100 is composed of one or more liquid crystal panels 102. FIG. 1 shows an embodiment in which the liquid crystal light control element 100 is composed of a first liquid crystal panel 1021, a second liquid crystal panel 1022, a third liquid crystal panel 1023, and a fourth liquid crystal panel 1024. The first liquid crystal panel 1021, the second liquid crystal panel 1022, the third liquid crystal panel 1023, and the fourth liquid crystal panel 1024 are arranged such that flat surfaces of the respective panels are stacked in a vertical direction.

The light source 204 emits light in a visible light band. The type of the light source 204 is not limited, and an LED light source, a fluorescent light source, an incandescent bulb light source, a mercury lamp, a halogen lamp, or the like can be used. The liquid crystal light control element 100 is an element that controls light distribution by utilizing an electro-optical effect of liquid crystals, and its mechanism will be described in detail in the present specification. As shown in FIG. 1, the liquid crystal light control element 100 is arranged so as to overlap the light emission opening 2023, and the light source 204 is arranged behind (below) the liquid crystal light control element 100. The lighting device 200 has a configuration in which a light distribution state of the light emitted from the light source 204 is controlled by the liquid crystal light control element 100 and the light is emitted to an external space through the light emission opening 2023.

The lighting device 200 is installed, for example, indoors. The lighting device 200 can be used for applications in which light is irradiated upward to illuminate a wall surface 301 and a ceiling 302. In other words, the lighting device 200 can be used for indirect lighting applications. As shown in FIG. 1, the lighting device 200 can be installed in contact with a wall 301 or close to the wall 301. The lighting device 200 is capable of dynamically changing a light distribution pattern while irradiating the wall surface 301 and the ceiling 302 with light distributed in a predetermined pattern by the liquid crystal light control element 100. The lighting device 200 can form illumination as if the light were fluctuating by the liquid crystal light control element 100, thereby creating an indoor atmosphere. Although details will be described later, the lighting device 200 can perform illumination by light in which light emitted from the light source 204 is distributed in a specific direction by the liquid crystal light control element 100. For example, light emitted from the light source 204 in all directions can be distributed in a line shape by the liquid crystal light control element 100, and the light distribution direction (the direction in which the linear light distribution extends) can be appropriately switched. Details of each element constituting such a lighting device 200 will be described below.

### 2. Liquid Crystal Panel

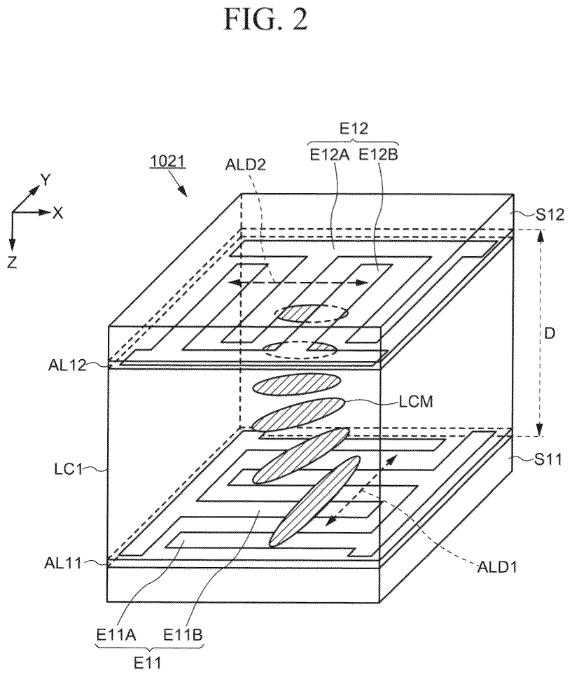

FIG. 2 is a perspective view of the first liquid crystal panel 1021 constituting the liquid crystal light control element 100. The first liquid crystal panel 1021 includes a first substrate S11, a second substrate S12, a first electrode E11, a second electrode E12, a first alignment film AL11, a second alignment film AL12, and a first liquid crystal layer LC1. The first electrode E11 is provided on the first substrate S11, and the second electrode E12 is provided on the second substrate S12. The first alignment film AL11 is provided on the first substrate S11 to cover the first electrode E11, and the second alignment film AL12 is provided on the second substrate S12 so as to cover the second electrode E12. The first liquid crystal layer LC1 is provided between the first substrate S11 and the second substrate S12.

The first electrode E11 includes a first strip electrode E11A and a second strip electrode E11B each having a strip-shaped pattern. The second electrode E12 includes a third strip electrode E12A and a fourth strip electrode E12B each having a strip-shaped pattern. The first strip electrode E11A and the second strip electrode E11B are alternately arranged on an insulating surface of the first substrate S11, and the third strip electrode E12A and the fourth strip electrode E12B are alternately arranged on an insulating surface of the second substrate S12.

FIG. 2 shows X, Y, and Z-axis directions for explanation. In the following description, expressions such as an X-axis direction, a Y-axis direction, and a Z-axis direction are used to specify directions; however, these expressions can be replaced with expressions such as a first direction for the X-axis direction, a second direction for the Y-axis direction, and a third direction or a vertical direction for the Z-axis direction.

The first strip electrode E11A and the plurality of second strip electrodes E11B extend in the X-axis direction, and the third strip electrode E12A and the plurality of fourth strip electrodes E12B extend in the Y-axis direction, in FIG. 2. The direction in which the third strip electrode E12A and the fourth strip electrode E12B extend intersects the direction in which the first strip electrode E11A and the second strip electrode E11B extend at an angle of, for example, 90±10 degrees, and is preferably orthogonal (90 degrees) thereto.

The extending direction of the strip electrodes constituting the first electrode E11 and the second electrode E12 may be inclined within a range of about ±10 degrees with respect to the X-axis direction and the Y-axis direction. Furthermore, a configuration in which the strip electrodes are partially bent while extending in a predetermined direction may be adopted. In this case, although the strip electrode has a plurality of extending directions along its length direction, each extending direction may be inclined by about ±10 degrees with respect to the X-axis direction or the Y-axis direction. Similarly, a configuration in which the strip electrodes are partially curved while extending in a predetermined direction may be adopted. In this case, a tangent direction at each position of the strip electrode is considered as the extending direction, and each extending direction may be inclined within a range of about ±10 degrees with respect to the X-axis direction or the Y-axis direction.

As in the embodiments described later, the extending direction of the strip electrodes constituting the first electrode E11 and the second electrode E12 may be inclined within a range of 30±10 degrees to 60±10 degrees with respect to the X-axis direction and the Y-axis direction.

The alignment direction ALD1 of the first alignment film AL11 is oriented in a direction (Y-axis direction) intersecting the direction in which the first strip electrode E11A and the second strip electrode E11B extend, and the alignment direction ALD2 of the second alignment film AL12 is oriented in a direction (X-axis direction) intersecting the direction in which the third strip electrode E12A and the fourth strip electrode E12B extend. An angle at which the direction in which the first strip electrode E11A and the second strip electrode E11B extend intersects the alignment direction ALD1, and an angle at which the direction in which the third strip electrode E12A and the fourth strip electrode E12B extend intersects the alignment direction ALD2 and can be set within a range of 90±10 degrees.

A distance D between the first substrate S11 and the second substrate S12 (hereinafter also sometimes referred to as a “cell gap”) can be appropriately set within a range of 10 μm to 100 μm, preferably within a range of 15 μm to 55 μm. The thicknesses of the first electrode E11, the second electrode E12, the first alignment film AL11, and the second alignment film AL12 are negligibly small compared to the distance between the first substrate S11 and the second substrate S12. Therefore, the distance between the first substrate S11 and the second substrate S12 can be regarded as the thickness of the first liquid crystal layer LC1. Although not shown in FIG. 2, a spacer may be provided between the first substrate S11 and the second substrate S12.

For the first liquid crystal layer LC1, for example, a twisted nematic (TN) liquid crystal is used. In a state where no voltage is applied to the first electrode E11 and the second electrode E12, the first liquid crystal layer LC1 is affected by the alignment anchoring force of the first alignment film AL11 and the second alignment film AL12, such that a major axis direction of liquid crystal molecules LCM is aligned parallel to the alignment directions ALD1 and ALD2 of the alignment films. Since the alignment direction ALD1 of the first alignment film AL11 and the alignment direction ALD2 of the second alignment film AL12 intersect (are orthogonal), the major axis direction of the liquid crystal molecules LCM gradually changes so as to twist by 90 degrees from the first substrate S11 to the second substrate S12.

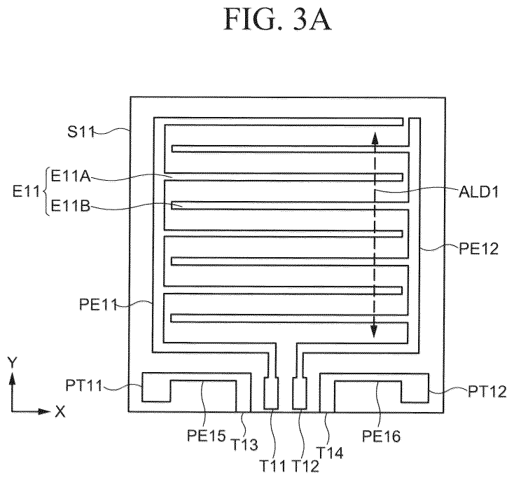

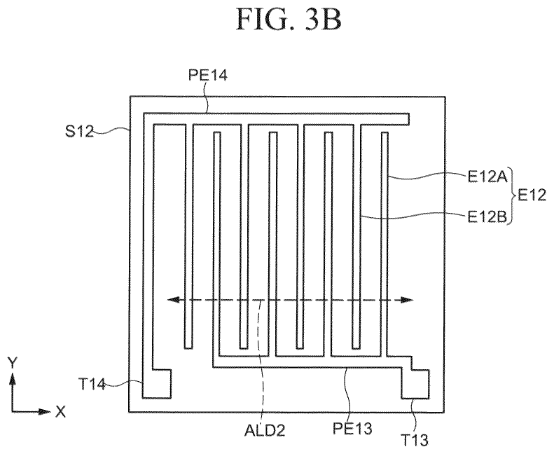

FIG. 3A is a plan view of the first substrate S11, and FIG. 3B is a plan view of the second substrate S12. As shown in FIG. 3A, the first electrode E11 has a structure in which a plurality of first strip electrodes E11A and a plurality of second strip electrodes E11B are alternately arranged at predetermined intervals. Further, as shown in FIG. 3B, the second electrode E12 has a structure in which a plurality of third strip electrodes E12A and a plurality of fourth strip electrodes E12B are alternately arranged at predetermined intervals.

As shown in FIG. 3A, each of the plurality of first strip electrodes E11A is connected to a first power supply line PE11, and each of the plurality of second strip electrodes E11B is connected to a second power supply line PE12. The first power supply line PE11 is connected to a first connection terminal T11, and the second power supply line PE12 is connected to a second connection terminal T12. The first connection terminal T11 and the second connection terminal T12 are provided at an end of the first substrate S11. On the first substrate S11, a third connection terminal T13 is provided adjacent to the first connection terminal T11, and a fourth connection terminal T14 is provided adjacent to the second connection terminal T12. The third connection terminal T13 is connected to a fifth power supply line PE15. The fifth power supply line PE15 is connected to a first power supply terminal PT11 provided on the first substrate S11. The fourth connection terminal T14 is connected to a sixth power supply line PE16. The sixth power supply line PE16 is connected to a second power supply terminal PT12 provided on the first substrate S11.

The same voltage is applied to the plurality of first strip electrodes E11A through the first power supply line PE11. The same voltage is applied to the plurality of second strip electrodes E11B through the second power supply line PE12. When different voltages are applied to the first connection terminal T11 and the second connection terminal T12, a potential difference is generated between the plurality of first strip electrodes E11A and the plurality of second strip electrodes E11B, and an electric field is generated. As a result, a lateral electric field (in the Y-axis direction) is generated by the plurality of first strip electrodes E11A and the plurality of second strip electrodes E11B.

As shown in FIG. 3B, each of the plurality of third strip electrodes E12A is connected to a third power supply line PE13, and each of the plurality of fourth strip electrodes E12B is connected to a fourth power supply line PE14. The third power supply line PE13 is connected to a third connection terminal T13, and the fourth power supply line PE14 is connected to a fourth connection terminal T14. A third power supply terminal PT13 is provided at a position corresponding to the first power supply terminal PT11 of the first substrate S11, and a fourth power supply terminal PT14 is provided at a position corresponding to the second power supply terminal PT12 of the first substrate S11. The third power supply terminal PT13 and the first power supply terminal PT11 are electrically connected, and the fourth power supply terminal PT14 and the second power supply terminal PT12 are electrically connected. A conductive paste is used for the electrical connection between these power supply terminals. As the conductive paste, for example, a silver paste is used.

When different voltages are applied to the third connection terminal T13 and the fourth connection terminal T14, a potential difference is generated between the plurality of third strip electrodes E12A and the plurality of fourth strip electrodes E12B, and an electric field is generated. As a result, a lateral electric field (in the X-axis direction) is generated by the plurality of third strip electrodes E12A and the plurality of fourth strip electrodes E12B.

The first substrate S11 and the second substrate S12 are light-transmitting substrates, such as glass substrates or resin substrates. The first electrode E11 and the second electrode E12 are transparent electrodes formed of indium tin oxide (ITO), indium zinc oxide (IZO), and the like. The power supply lines (the first power supply line PE11, the second power supply line PE12, the third power supply line PE13, and the fourth power supply line PE14) and the connection terminals (the first connection terminal T11, the second connection terminal T12, the third connection terminal T13, and the fourth connection terminal T14) are formed of a metallic material such as aluminum, titanium, molybdenum, or tungsten. Note that the power supply lines (the first power supply line PE11, the second power supply line PE12, the third power supply line PE13, and the fourth power supply line PE14) may be formed of the same transparent conductive film as the first electrode E11 and the second electrode E12. Of course, a configuration in which one or both of the first electrode E11 and the second electrode E12 are formed of a metallic material or a stack of a transparent conductive film and a metallic material may also be adopted.

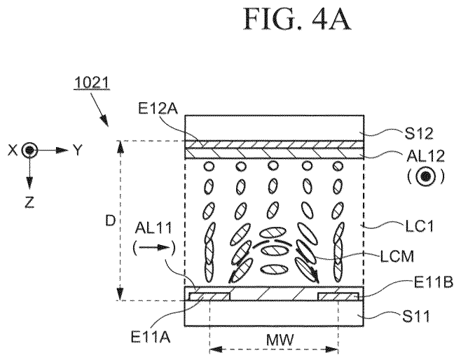

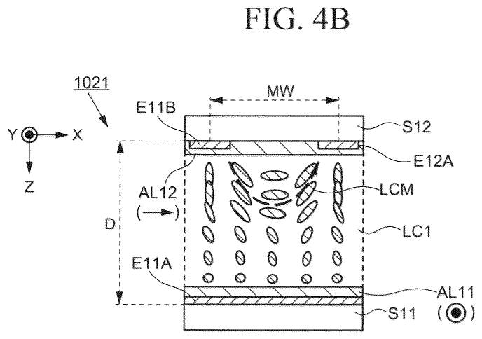

FIG. 4A is a partial cross-sectional view of the first liquid crystal panel 1021 when viewed from a direction perpendicular to the direction in which the first strip electrode E11A and the second strip electrode E11B extend, and FIG. 4B is a partial cross-sectional view of the first liquid crystal panel 1021 when viewed from a direction perpendicular to the direction in which the third strip electrode E12A and the fourth strip electrode E12B extend. FIG. 4A and FIG. 4B use symbols to indicate that the alignment direction ALD1 of the first alignment film AL11 and the alignment direction ALD2 of the second alignment film AL12 are different from each other.

As shown in FIG. 4A and FIG. 4B, the first strip electrode E11A and the second strip electrode E11B are arranged with a center-to-center distance MW, and the third strip electrode E12A and the fourth strip electrode E12B are arranged with a center-to-center distance MW. A distance D between the first substrate S11 and the second substrate S12, which corresponds to the thickness of the first liquid crystal layer LC1, has a size equal to or greater than the center-to-center distance MW of the strip electrodes (D≥MW). For example, the distance D preferably has a size twice or more than the center-to-center distance MW of the strip electrodes. For example, when the center-to-center distance MW is 16 μm, the distance D preferably has a size of 16 μm or more, for example, a size of 20 μm is preferable, and a size of 30 μm is more preferable.

The refractive index of a liquid crystal changes depending on its alignment state. In a state where no electric field is acting on the first liquid crystal layer LC1, as shown in FIG. 2, the major axis direction of the liquid crystal molecules LCM is aligned horizontally to the surface of the substrate and is aligned in a state of being twisted by 90 degrees from the first substrate S11 side toward the second substrate S12 side. At this time, the first liquid crystal layer LC1 has a uniform refractive index distribution. When light is incident on the first liquid crystal panel 1021, the polarization component of the incident light undergoes optical rotation due to the twist of the liquid crystal molecules LCM. At this time, the incident light passes through the first liquid crystal layer LC1 without being refracted (or scattered) while undergoing optical rotation.

On the other hand, as shown in FIG. 4A, when an electric field is generated between the first strip electrode E11A and the second strip electrode E11B, the major axes of the liquid crystal molecules LCM are aligned along the electric field (when the liquid crystal has positive dielectric anisotropy). As a result, as shown in FIG. 4A, a region is formed where the liquid crystal molecules LCM stand up above the first strip electrode E11A and the second strip electrode E11B, a region is formed where the liquid crystal molecules LCM are aligned obliquely along the distribution of the electric field between the first strip electrode E11A and the second strip electrode E11B, and a region is formed where an initial alignment state is maintained in a region distant from the first substrate S11.

Similarly, as shown in FIG. 4B, when an electric field is generated between the third strip electrode E12A and the fourth strip electrode E12B, a region is formed where the liquid crystal molecules LCM stand up above the third strip electrode E12A and the fourth strip electrode E12B, a region is formed where the liquid crystal molecules LCM are aligned obliquely along the distribution of the electric field between the third strip electrode E12A and the fourth strip electrode E12B, and a region is formed where the initial alignment state is maintained in a region distant from the second substrate S12.

Hereinafter, the electric field generated by the first strip electrode E11A and the second strip electrode E11B, and the third strip electrode E12A and the fourth strip electrode E12B may also be referred to as a “lateral electric field”.

As shown in FIG. 4A and FIG. 4B, when an electric field is generated between the first strip electrode E11A and the second strip electrode E11B, and between the third strip electrode E12A and the fourth strip electrode E12B, a region is formed in which the liquid crystal molecules LCM are aligned in a convex arc shape such that major axes of the liquid crystal molecules follow a direction in which the electric field is generated. That is, as shown in FIG. 4A, when the direction of the initial alignment of the liquid crystal molecules LCM is the same as the direction of the lateral electric field, the liquid crystal molecules LCM are aligned while being inclined (tilted) in a normal direction with respect to the surface of the first substrate S11 according to the intensity distribution of the electric field.

As shown in FIG. 4A, since the distance D is sufficiently large, the influence of the electric field on the first substrate S11 side on the alignment of the liquid crystal molecules on the second substrate S12 side is remarkably small, and the alignment state of the liquid crystal molecules LCM on the second substrate S12 side is hardly affected by the electric field generated on the first substrate S11 side. The same applies to FIG. 4B; the alignment state of the liquid crystal molecules LCM on the second substrate S12 side changes under the influence of the electric field generated by the third strip electrode E12A and the fourth strip electrode E12B, but the liquid crystal molecules LCM on the first substrate S11 side are hardly affected by this electric field.

By forming the lateral electric field with the strip electrodes, a convex arc-shaped dielectric constant distribution is formed in the first liquid crystal layer LC1. Among the light incident on the first liquid crystal layer LC1, a polarization component parallel to the direction of the initial alignment of the liquid crystal molecules LCM is diffused radially by the dielectric constant distribution. As shown in FIG. 4A and FIG. 4B, since the direction of the initial alignment of the liquid crystal molecules LCM intersects (is orthogonal) between the first substrate S11 side and the second substrate S12 side, it is possible to diffuse light in different directions on the first substrate S11 side and the second substrate S12 side, respectively.

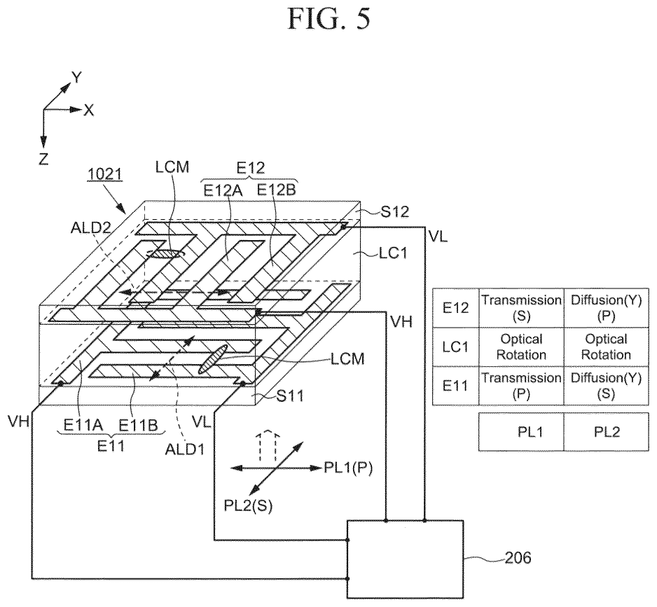

FIG. 5 shows the first liquid crystal panel 1021 in a state where the first strip electrode E11A and the second strip electrode E11B of the first electrode E11 extend in the X-axis direction, and the third strip electrode E12A and the fourth strip electrode E12B of the second electrode E12 extend in the Y-axis direction. The alignment direction ALD1 of the first alignment film AL11 is parallel to the Y-axis direction, and the alignment direction ALD2 of the second alignment film AL12 is parallel to the X-axis direction. Therefore, the major axes of the liquid crystal molecules LCM on the first substrate S11 side are oriented toward the Y-axis direction, and the major axis direction of the liquid crystal molecules LCM on the second substrate S12 side is oriented toward the X-axis direction. Further, FIG. 5 shows a state where, from the control circuit 206, a high-level voltage VH is applied to the first strip electrode E11A, a low-level voltage VL (VH>VL) is applied to the second strip electrode E11B, a high-level voltage VH is applied to the third strip electrode E12A, and a low-level voltage VL (VH>VL) is applied to the fourth strip electrode E12B.

Light emitted from the light source is incident on the first liquid crystal panel 1021 from the first substrate S11 side. This light has a first polarization component PL1 and a second polarization component PL2. Here, it is assumed that the first polarization component PL1 corresponds to a P-wave (having an amplitude in the X-axis direction) and the second polarization component PL2 corresponds to an S-wave (having an amplitude in the Y-axis direction). As shown in the table inserted in FIG. 5, the light incident on the first liquid crystal panel 1021 undergoes optical effects such as transmission, optical rotation, and diffusion from the first liquid crystal layer LC1.

Here, “transmission” shown in the table refers to a predetermined polarization component passing through as is, without its polarization axis or light distribution state changing. As described above, “optical rotation” refers to a phenomenon in which the polarization axis of a linearly polarized light component rotates as it passes through the liquid crystal layer. Further, “diffusion (X)” indicates that a polarization component is diffused in the X-axis direction, and “diffusion (Y)” indicates that a polarization component is diffused in the Y-axis direction. The notation shown in the table in FIG. 5 is the same for each of the embodiments described hereinafter.

Among the light incident from the first substrate S11 side, the first polarization component PL1 is a P-wave. The direction of the polarization axis of the first polarization component PL1 intersects the major axis direction of the liquid crystal molecules LCM on the first electrode E11 side. Therefore, the first polarization component PL1 passes through as is without being affected by the refractive index distribution formed by the liquid crystal molecules LCM. As the first polarization component PL1 travels through the first liquid crystal layer LC1 from the first substrate S11 side to the second substrate S12 side, it undergoes optical rotation by 90 degrees and transitions to an S-wave state. Since the first polarization component PL1 becomes an S-wave on the second electrode E12 side, its polarization direction intersects the major axis direction of the liquid crystal molecules LCM. This first polarization component PL1 passes through as is without being affected by the refractive index distribution formed by the liquid crystal molecules LCM. On the other hand, the second polarization component PL2 is an S-wave. Since the direction of the polarization axis of the second polarization component PL2 is parallel to the major axis direction of the liquid crystal molecules LCM on the first electrode E11 side, it is affected by the refractive index distribution formed by the liquid crystal molecules LCM and diffuses in the Y-axis direction. As the second polarization component PL2 travels through the first liquid crystal layer LC1 from the first substrate S11 side to the second substrate S12 side, it undergoes optical rotation by 90 degrees and transitions to a P-wave state. The polarization direction of this second polarization component PL2 is parallel to the major axis direction of the liquid crystal molecules LCM on the second electrode E12 side. Therefore, this second polarization component PL2 is affected by the refractive index distribution formed by the liquid crystal molecules LCM and diffuses in the X-axis direction.

As described above, when light is incident on the first liquid crystal panel 1021 shown in FIG. 5, the first polarization component PL1 (P-wave) is emitted in an S-wave state after undergoing optical rotation in the first liquid crystal layer LC1 without being diffused. The second polarization component PL2 (S-wave) is diffused once in each of the Y-axis direction and the X-axis direction and is emitted in a P-wave state after undergoing optical rotation in the first liquid crystal layer LC1.

Although FIG. 5 shows an example in which a voltage is applied to each of the first electrode E11 and the second electrode E12, the light emitted from the light source can be distributed into a line-shaped light distribution pattern extending in the X-axis direction or a line-shaped light distribution pattern extending in the Y-axis direction by changing the voltage application conditions.

### 3. Liquid Crystal Light Control Element

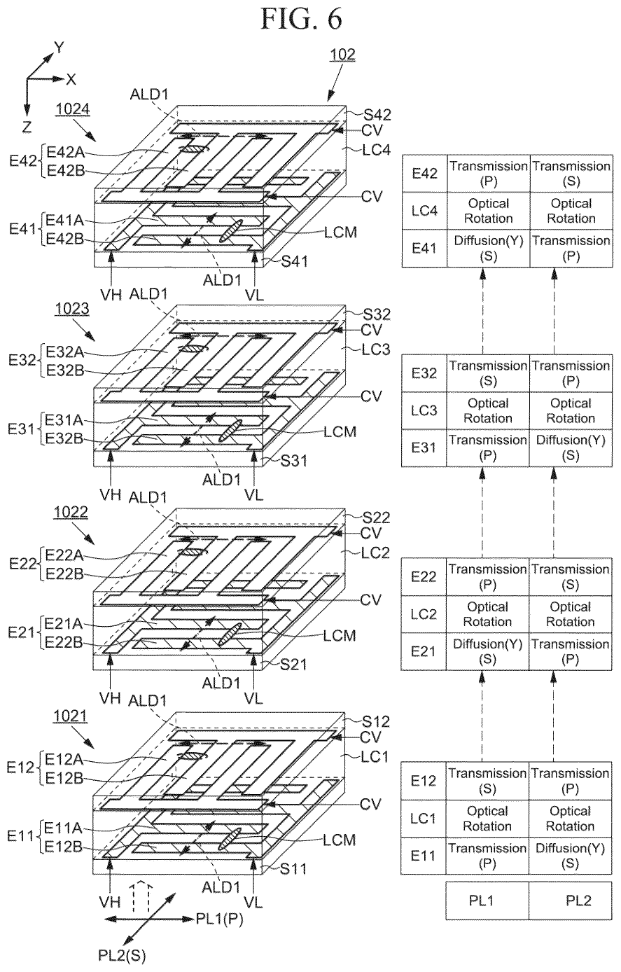

The liquid crystal light control element 100 is composed of a plurality of liquid crystal panels having the same configuration as the first liquid crystal panel 1021. FIG. 6 shows the liquid crystal light control element 100 composed of a plurality of liquid crystal panels. The liquid crystal light control element 100 has a structure in which a first liquid crystal panel 1021, a second liquid crystal panel 1022, a third liquid crystal panel 1023, and a fourth liquid crystal panel 1024 are stacked in the Z-axis direction. For purposes of explanation, FIG. 6 shows the liquid crystal panels as being spaced apart from each other, but the actual liquid crystal light control element 100 has a structure in which the liquid crystal panels are bonded with a light-transmitting adhesive.

The second liquid crystal panel 1022, the third liquid crystal panel 1023, and the fourth liquid crystal panel 1024 have the same configuration as the first liquid crystal panel 1021 shown in FIG. 5. FIG. 6 shows a configuration in which the first liquid crystal panel 1021 includes a first substrate S11, a second substrate S12, a first electrode E11, and a second electrode E12. Similar to such a configuration, the second liquid crystal panel 1022 has a first substrate S21, a second substrate S22, a first electrode E21, and a second electrode E22; the third liquid crystal panel 1023 has a first substrate S31, a second substrate S32, a first electrode E31, and a second electrode E32; and the fourth liquid crystal panel 1024 has a first substrate S41, a second substrate S42, a first electrode E41, and a second electrode E42.

The first electrodes E11, E21, E31, and E41 are composed of first strip electrodes E11A, E21A, E31A, and E41A and second strip electrodes E11B, E21B, E31B, and E41B, and these strip electrodes extend in the X-axis direction. The second electrodes E12, E22, E32, and E42 are composed of third strip electrodes E12A, E22A, E32A, and E42A and fourth strip electrodes E12B, E22B, E32B, and E42B, and these strip electrodes extend in the Y-axis direction.

In the first liquid crystal panel 1021, the second liquid crystal panel 1022, the third liquid crystal panel 1023, and the fourth liquid crystal panel 1024, the direction in which the first strip electrodes E11A, E21A, E31A, and E41A and the second strip electrodes E11B, E21B, E31B, and E41B extend is the same, and the direction in which the third strip electrodes E12A, E22A, E32A, and E42A and the fourth strip electrodes E12B, E22B, E32B, and E42B extend is the same. A low-level voltage VL, a high-level voltage VH, and a constant voltage CV are applied to each liquid crystal panel as control signals. The low-level voltage VL is, for example, a voltage of 0 V or −15 V, and the high-level voltage VH is, for example, 30 V (with respect to VL=0 V) or 15 V (with respect to VL=−15 V). The constant voltage CV is, for example, an intermediate voltage between VL and VH or a 0 V (ground) voltage signal.

FIG. 6 shows a state where a high-level voltage VH and a low-level voltage VL are applied as control signals to the first electrode E11 of the first liquid crystal panel 1021, the first electrode E21 of the second liquid crystal panel 1022, the first electrode E31 of the third liquid crystal panel 1023, and the first electrode E41 of the fourth liquid crystal panel 1024, and a constant voltage CV is applied as a control signal to the second electrode E12 of the first liquid crystal panel 1021, the second electrode E22 of the second liquid crystal panel 1022, the second electrode E32 of the third liquid crystal panel 1023, and the second electrode E42 of the fourth liquid crystal panel 1024. That is, the liquid crystal molecules are aligned by a lateral electric field on the side of the first substrates S11, S21, S31, and S41 of the respective liquid crystal panels, while the liquid crystal molecules are in an initial alignment state on the side of the second substrates S12, S22, S32, and S42.

FIG. 6 shows that light emitted from the light source is incident from the first liquid crystal panel 1021 side and is emitted from the fourth liquid crystal panel 1024 side. The incident light includes a first polarization component PL1 (P-wave) and a second polarization component PL2 (S-wave), and the table inserted in FIG. 6 shows how diffusion, optical rotation, and transmission change in each of the liquid crystal panels.

For example, looking at the first liquid crystal panel 1021, the first polarization component PL1 (P-wave) of the light emitted from the light source is transmitted on the first electrode E11 side, transitions to an S-wave by undergoing optical rotation in the process of passing through the first liquid crystal layer LC1, and is transmitted and emitted on the second electrode E12 side; and the second polarization component PL2 (S-wave) is diffused in the Y-axis direction on the first electrode E11 side, transitions to a P-wave by undergoing optical rotation in the process of passing through the first liquid crystal layer LC1, and is transmitted and emitted on the second electrode E12 side. In this way, as the first polarization component PL1 and the second polarization component PL2 pass through the first liquid crystal panel 1021, the directions of their polarization axes rotate and they are diffused by the influence of the electric field. Such a change is repeated each time they pass through the second liquid crystal panel 1022, the third liquid crystal panel 1023, and the fourth liquid crystal panel 1024.

As shown in the table inserted in FIG. 6, the first polarization component (P-wave) of the light emitted from the light source passes through the first liquid crystal panel 1021 to the fourth liquid crystal panel 1024, whereby it is diffused in the Y-axis direction in each of the second liquid crystal panel 1022 and the fourth liquid crystal panel 1024 (twice in total), undergoes optical rotation four times in the liquid crystal layers of the respective liquid crystal panels, and is emitted in a P-wave state. Further, the second polarization component PL2 (S-wave) passes through the first liquid crystal panel 1021 to the fourth liquid crystal panel 1024, whereby it is diffused in the Y-axis direction in each of the first liquid crystal panel 1021 and the third liquid crystal panel 1023 (twice in total), undergoes optical rotation four times in the liquid crystal layers of the respective liquid crystal panels, and is emitted in an S-wave state. That is, the voltage application conditions shown in FIG. 6 result in the light emitted from the light source being distributed while being spread in the Y-axis direction. Since such a light distribution pattern spreads light in a uniaxial direction, it can be referred to as line light distribution. Furthermore, as shown in FIG. 6, by driving only the electrodes on one substrate side of each liquid crystal panel, a polarization component that undergoes optical rotation in the process of passing through the liquid crystal panel can be diffused in only one direction, and a reduction in the sharpness of light diffusivity in a predetermined direction caused by diffusion occurring both before and after the optical rotation is suppressed. This means that the light diffusion direction can be limited by driving only the electrodes on one substrate side of each liquid crystal panel, and only the polarization component in a direction parallel to the alignment direction of the alignment film covering those electrodes can be diffused. Therefore, by making the directions of the electrodes of the respective liquid crystal panels different from each other, polarization components of incident light in various directions can be diffused. This will be described in detail in the subsequent embodiments.

Note that the voltage application conditions shown in FIG. 6 are merely an example, and the voltage application conditions applicable to the liquid crystal light control element 100 are not limited to those illustrated. For example, by applying a constant voltage CV as a control signal to the first electrode of each liquid crystal panel and applying a high-level voltage VH and a low-level voltage VL as control signals to the second electrode, a line light distribution pattern spreading in the X-axis direction can be formed. The number of liquid crystal panels constituting the liquid crystal light control element 100 is not limited to four, and the number can be further increased. Furthermore, the manner in which the liquid crystal panels are stacked can be varied. For example, an upper liquid crystal panel can be rotated by a predetermined angle relative to a lower liquid crystal panel and then stacked.

### 4. Shape of Housing

As described with reference to FIG. 6, the light distribution of the light emitted from the light source 204 is controlled by the liquid crystal light control element 100. The lighting device 200 can create lighting effects in an indoor space by emitting the light whose distribution has been controlled by the liquid crystal light control element 100. In order to effectively create effects with the light whose distribution is controlled by the liquid crystal light control element 100, it is necessary to arrange the lighting device 200 in an appropriate direction so that walls or a ceiling is illuminated by the distributed light. That is, it is required that a user be able to identify in which direction the lighting device 200 should be installed.

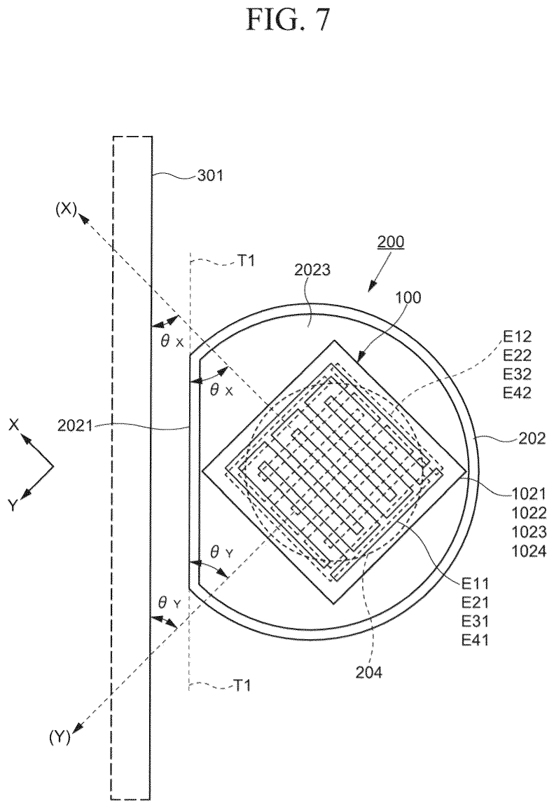

FIG. 7 shows a top view of a housing 202 used in the lighting device 200. The housing 202 has a space inside for accommodating the liquid crystal light control element 100 and the light source 204 and has a light emission opening 2023 on the top surface. As shown in FIG. 7, when viewed from the top, the housing 202 has a shape in which a part of a circular outline is cut away in a linear shape. Although the side surface (body) of the housing 202 has a curved shape, this cut-away portion is formed into a flat shape. This flat portion differs in appearance from the shapes of other portions of the housing 202 and forms a reference surface 2021 that can be identified from the appearance.

Since this reference surface 2021 is formed by a flat surface within the cylindrical appearance of the housing 202, it can be expected to have a psychological effect that naturally guides a user to install the device with this surface facing a wall. In this way, by making a part of the shape of the housing 202 visually distinguishable from other parts, that part can be used as the reference surface 2021, and a reference direction (a direction for facing the housing 202 toward a wall surface 301) can be indicated when arranging the lighting device 200.

FIG. 7 shows that the reference surface 2021 provided on the housing 202 is installed facing toward a wall surface 301. In the liquid crystal light control element 100, the direction in which light is diffused is determined by the direction in which the strip patterns of the electrodes extend. Therefore, when installing the liquid crystal light control element 100 in the housing 202, it is necessary to pay attention to the positioning of the reference surface 2021 and the direction in which the strip electrodes extend.

FIG. 7 shows a top view of the liquid crystal light control element 100 inside the housing 202. As described with reference to FIG. 6, when the strip electrodes forming the first electrodes E11, E21, E31, and E41 extend in the X-axis direction and the second electrodes E12, E22, E32, and E42 extend in the Y-axis direction, it is preferable that the liquid crystal light control element 100 be arranged in the housing 202 such that the extension of a tangent line T1 to the flat surface forming the reference surface 2021 and the X-axis and Y-axis directions do not intersect at right angles but intersect at an angle smaller than 90 degrees, as shown in FIG. 7. In this case, the angle θₓ at which the tangent line T1 and the X-axis direction intersect and the angle θ_{y} at which the tangent line T1 and the Y-axis direction intersect may be equal in magnitude, or one may be larger than the other. For example, both the angle θₓ at which the tangent line T1 and the X-axis direction intersect and the angle θ_{y} at which the tangent line T1 and the Y-axis direction intersect may be 45 degrees, or when one angle becomes larger, the other angle may become smaller so that each of the angles θₓ and θ_{y} satisfies a supplementary angle relationship.

By arranging the liquid crystal light control element 100 in the housing 202 with the reference surface 2021 as a reference in this manner, the lighting device 200 can be installed such that the extensions of both the X-axis direction and the Y-axis direction intersect the wall surface 301 obliquely instead of at right angles. Thereby, when light that has been line-distributed in the X-axis direction and the Y-axis direction is emitted by the liquid crystal light control element 100, both of the line-distributed light beams can be irradiated onto the wall surface 301.

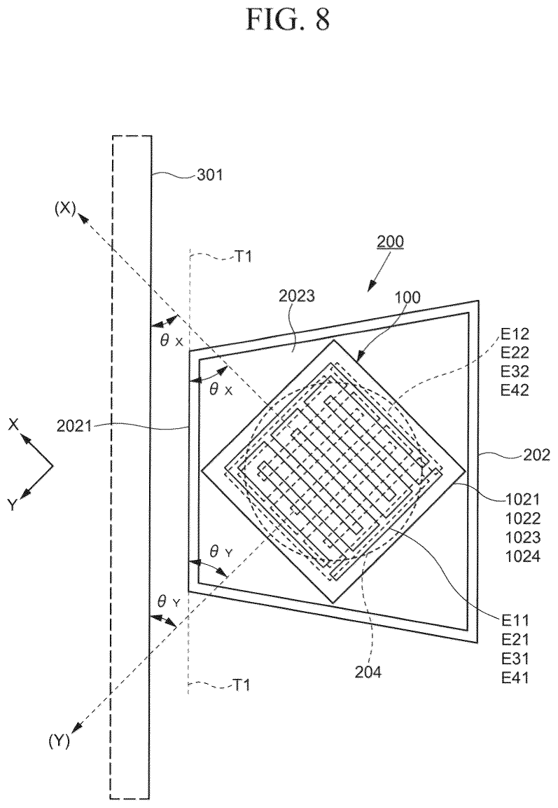

The shape of the housing 202 is not limited to a circular shape in a plan view. For example, as shown in FIG. 8, it may be rectangular in a plan view. The housing 202 shown in FIG. 8 has a reference surface 2021 formed of a flat surface, similar to the example shown in FIG. 7. When the shape of the housing 202 is rectangular in a plan view, the side surfaces of the housing 202 are formed of flat surfaces, which may make the reference surface 2021 indistinguishable from the other surfaces. In such a case, the shape of the housing 202 may be formed in a trapezoidal shape in a plan view so that the flat surface serving as the reference surface 2021 can be visually distinguished. Since a trapezoid has two opposing sides formed of a short side and a long side, the surface on the short side and the surface on the long side of the trapezoid can be distinguished from each other by appearance, and the surface serving as the reference surface 2021 can be identified separately from the other surfaces. Although FIG. 8 shows the surface on the short side of the trapezoid as the reference surface 2021, the surface on the long side may also be used as the reference surface 2021.

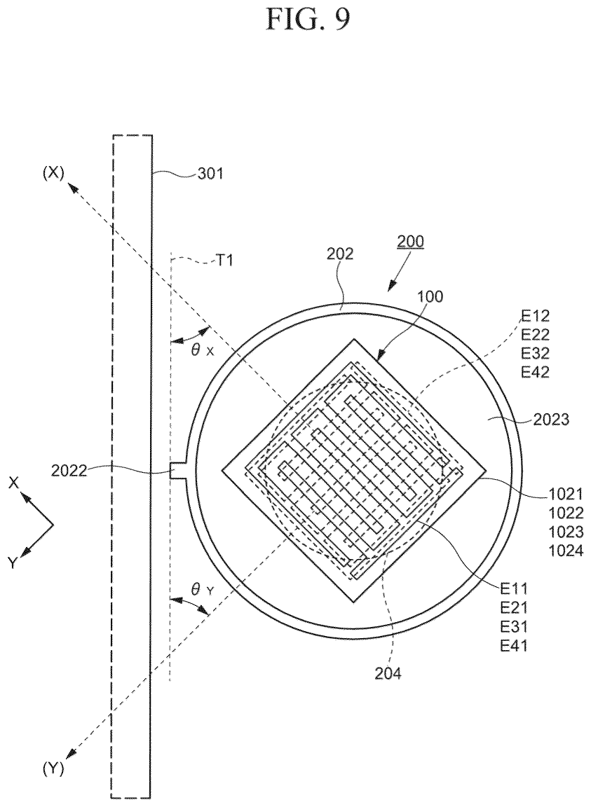

The portion provided on the housing 202 to indicate the reference direction is not limited to a planar shape. For example, as shown in the top view of the housing 202 in FIG. 9, a marker 2022 may be formed by a shape in which a part of the housing 202 protrudes outward. In this way, even without providing a flat portion on the housing 202, by providing the marker 2022 with a visually identifiable shape, it is possible to indicate the reference direction when arranging the lighting device 200. In this case, by arranging the liquid crystal light control element 100 inside the housing 202 with respect to a tangent line T1 touching the marker 2022 in the same manner as described for FIG. 7, both the X-axis direction and the Y-axis direction can be made to intersect the wall surface 301.

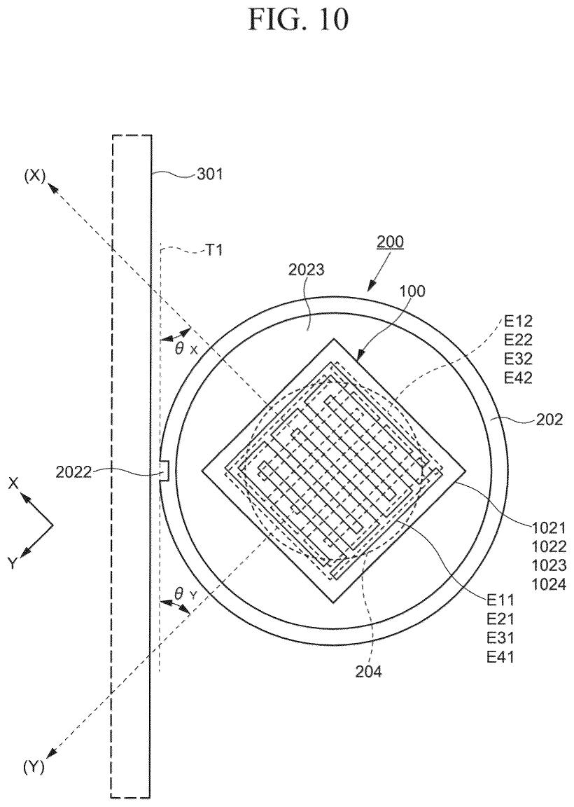

Furthermore, as shown in FIG. 10, the shape of the marker 2022 is not limited to a convex shape protruding to the outside of the housing 202, and it may have a concave shape. By forming a part of the outer surface of the housing 202 into a concave shape, it is possible to form a portion that is distinguishable from other portions in terms of its external appearance, thereby forming a visually recognizable identification part.

Note that the convex marker 2022 shown in FIG. 9 and the concave marker 2022 shown in FIG. 10 may be formed throughout the entire vertical length of the side surface of the housing 202 or may be formed partially. For example, the convex or concave marker 2022 may be formed on the upper side of the side surface of the housing 202 to be easily visible from its external appearance.

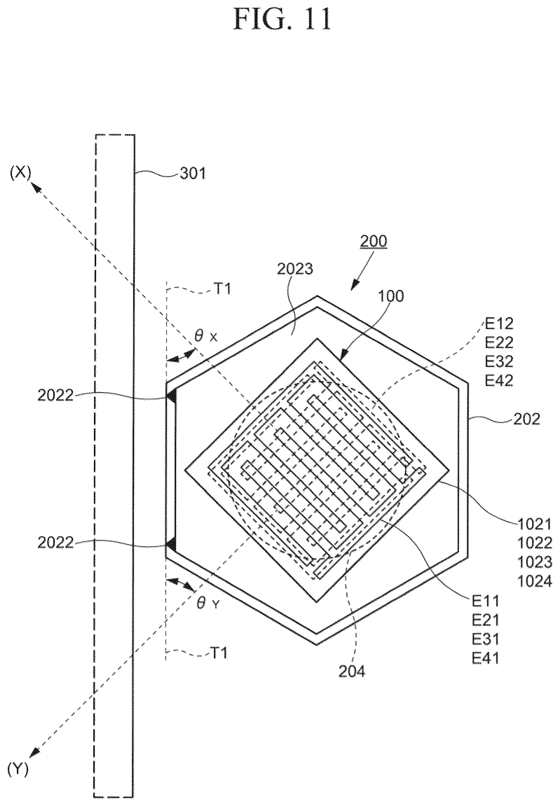

Furthermore, as shown in FIG. 11, the marker 2022 may be formed as a mark applied to the housing 202, rather than by varying the shape of a part of the housing 202. This mark may be represented by characters, figures, or symbols, and may be colored. FIG. 11 shows a case where the housing 202 is hexagonal in a plan view, but by displaying the marker 2022 with characters, figures, or symbols, it is possible to avoid affecting the external shape of the housing 202. Even when a complex design is applied to the exterior of the housing 202, using a marker 2022 represented by characters, figures, or symbols makes it possible to avoid affecting the design.

As described with reference to FIG. 7 to FIG. 11, by providing a reference surface 2021 or a marker 2022 that can be identified from the appearance on a part of the housing 202, the lighting device 200 can be installed facing the wall surface 301 in accordance with the direction in which light is distributed by the liquid crystal light control element 100.

### 3. Configuration and Driving Method of Liquid Crystal Light Control Element

As described with reference to FIG. 6, the liquid crystal light control element 100 is composed of a plurality of liquid crystal panels. There are various variations in the number of liquid crystal panels to be stacked and the way they are stacked, and the state of the light irradiated onto an irradiation surface can be varied accordingly. Several specific examples are shown below.

### First Embodiment

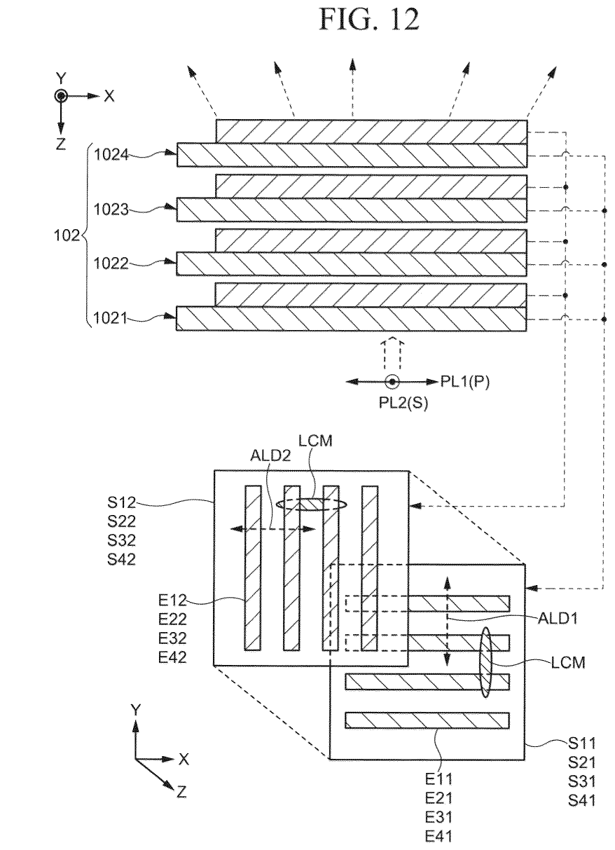

FIG. 12 shows a configuration of a liquid crystal light control element 100 used in a lighting device 200. FIG. 12 illustrates an example in which the liquid crystal light control element 100 is composed of four liquid crystal panels (a first liquid crystal panel 1021, a second liquid crystal panel 1022, a third liquid crystal panel 1023, and a fourth liquid crystal panel 1024). The first liquid crystal panel 1021, the second liquid crystal panel 1022, the third liquid crystal panel 1023, and the fourth liquid crystal panel 1024 are stacked in the Z-axis direction. FIG. 12 shows that the first liquid crystal panel 1021, the second liquid crystal panel 1022, the third liquid crystal panel, and the fourth liquid crystal panel 1024 are stacked in this order from the bottom. Furthermore, FIG. 12 shows that light emitted from a light source is incident on the first liquid crystal panel 1021 and emitted from the fourth liquid crystal panel 1024. In this case, it is assumed that, in the light incident on the first liquid crystal panel 1021, a first polarization component PL1 is a P-wave having an amplitude in the X-axis direction, and a second polarization component PL2 is an S-wave having an amplitude in the Y-axis direction. Then, it is assumed that the first polarization component PL1 undergoes optical rotation each time it passes through a liquid crystal layer, transitioning from a P-wave to an S-wave, and then transitioning from an S-wave back to a P-wave upon passing through the next liquid crystal layer. The same applies to the second polarization component PL2 (S-wave).

In each liquid crystal panel, first electrodes E11, E21, E31, and E41 extending in the X-axis direction are provided on the first substrates S11, S21, S31, and S41, and second electrodes E12, E22, E32, and E42 extending in the Y-axis direction are provided on the second substrates S12, S22, S32, and S42. The strip electrodes of the first electrodes E11, E21, E31, and E41 and the strip electrodes of the second electrodes E12, E22, E32, and E42 are provided to intersect at an angle of 90±10 degrees. The alignment direction ALD1 of the alignment film on the side of the first substrates S11, S21, S31, and S41 is oriented toward the Y-axis direction, and the alignment direction ALD2 of the alignment film on the side of the second substrates S12, S22, S32, and S42 is oriented toward the X-axis direction.

As described with reference to FIG. 6, it is possible to apply, to the first electrodes E11, E21, E31, and E41 and the second electrodes E12, E22, E32, and E42, a control voltage for aligning liquid crystal molecules by a lateral electric field (a voltage application condition using the high-level voltage VH and the low-level voltage VL) or a control voltage that does not change the alignment state of the liquid crystal molecules (a voltage application condition using the constant voltage CV).

Tables 1 and 2 show the voltage application conditions for the liquid crystal light control element 100 according to the present embodiment. In Table 1, the column labeled “Liquid Crystal Panel” indicates numbers corresponding to the first to fourth liquid crystal panels 1021, 1022, 1023, and 1024. The column labeled “Electrode” indicates the direction in which the strip electrodes of each liquid crystal panel extend; in Table 1, as described with reference to FIG. 12, this indicates that in each liquid crystal panel, the direction in which the strip electrodes of the first electrodes E11, E21, E31, and E41 extend and the direction in which the strip electrodes of the second electrodes E12, E22, E32, and E42 extend are arranged to intersect at an angle of 90±10 degrees. The figures in the column labeled “Liquid Crystal” indicate the alignment direction of the liquid crystal molecules on each substrate (the major axis direction of the liquid crystal molecules coincides with the initial alignment direction of the alignment film). The column labeled “Drive” indicates the state of application of control voltages to the first electrodes E11, E21, E31, and E41 and the second electrodes E12, E22, E32, and E42, where “ON” indicates that the high-level voltage VH and the low-level voltage VL are applied to control the alignment state of the liquid crystal molecules by a lateral electric field, and “OFF” indicates a state where the constant voltage CV is applied. In the column labeled “Alignment Direction of Alignment Film,” the alignment direction of the alignment film provided in each liquid crystal panel is indicated by arrows. Here, an arrow pointing in the horizontal direction indicates that the alignment direction of the alignment film is parallel to the X-axis direction, and an arrow pointing in the vertical direction indicates that the alignment direction of the alignment film is parallel to the Y-axis direction. The column labeled “Diffusion Direction of Polarization Component” indicates the direction in which the first polarization component or the second polarization component is diffused. Here, “Diffusion (X)” indicates that the polarization component is diffused in the X-axis direction, “Diffusion (Y)” indicates that the polarization component is diffused in the Y-axis direction, and “Transmission” refers to the polarization axis of a predetermined polarization component not changing and the light distribution state not changing, such that the light is transmitted as is. The display contents of each column in Table 1 are the same in the subsequent embodiments.

Table 1 shows the first voltage application conditions in the present embodiment and the state in which polarization components are diffused in each liquid crystal panel.

TABLE 1

| | | | Alignment | Diffusion Direction |
|---|---|---|---|---|
| LC | | | Direction of | of Polarization |
| Panel | Electrode | Drive | Alignment Film | Component |
| 4 | E42 | OFF | [symbol] | Transmission |
| | E41 | ON | [symbol] | Diffusion (Y) |
| 3 | E32 | OFF | [symbol] | Transmission |
| | E31 | ON | [symbol] | Diffusion (Y) |
| 2 | E22 | OFF | [symbol] | Transmission |
| | E21 | ON | [symbol] | Diffusion (Y) |
| 1 | E12 | OFF | [symbol] | Transmission |
| | E11 | ON | [symbol] | Diffusion (Y) |

The first voltage application condition shown in Table 1 is a condition in which the first electrodes E11, E21, E31, and E41 are turned ON to align liquid crystal molecules by a lateral electric field, and the second electrodes E12, E22, E32, and E42 are turned OFF. Under such conditions, the first polarization component PL1 is diffused in the Y-axis direction at the first electrode E21 of the second liquid crystal panel 1022 and the first electrode E41 of the fourth liquid crystal panel 1024, and the second polarization component PL2 is diffused in the Y-axis direction at the first electrode E11 of the first liquid crystal panel 1021 and the first electrode E31 of the third liquid crystal panel 1023. That is, under the first voltage application condition, both the first polarization component PL1 and the second polarization component PL2 are diffused in the Y-axis direction, forming a line light distribution (L1) in which light is diffused in the Y-axis direction.

Table 2 shows the second voltage application conditions in the present embodiment and the state in which polarization components are diffused in each liquid crystal panel.

TABLE 2

| | | | Alignment | Diffusion Direction |
|---|---|---|---|---|
| LC | | | Direction of | of Polarization |
| Panel | Electrode | Drive | Alignment Film | Component |
| 4 | E42 | ON | [symbol] | Diffusion (X) |
| | E41 | OFF | [symbol] | Transmission |
| 3 | E32 | ON | [symbol] | Diffusion (X) |
| | E31 | OFF | [symbol] | Transmission |
| 2 | E22 | ON | [symbol] | Diffusion (X) |
| | E21 | OFF | [symbol] | Transmission |
| 1 | E12 | ON | [symbol] | Diffusion (X) |
| | E11 | OFF | [symbol] | Transmission |

The second voltage application condition shown in Table 2 is a condition in which the first electrodes E11, E21, E31, and E41 are turned OFF, and the second electrodes E12, E22, E32, and E42 are turned ON to align liquid crystal molecules by a lateral electric field. Under such conditions, the first polarization component PL1 is diffused in the X-axis direction at the second electrode E22 of the second liquid crystal panel 1022 and the second electrode E42 of the fourth liquid crystal panel 1024, and the second polarization component PL2 is diffused in the X-axis direction at the second electrode E12 of the first liquid crystal panel 1021 and the second electrode E32 of the third liquid crystal panel 1023. That is, under the second voltage application condition, both the first polarization component PL1 and the second polarization component PL2 are diffused in the X-axis direction, forming a line light distribution (L2) in which light is diffused in the X-axis direction.

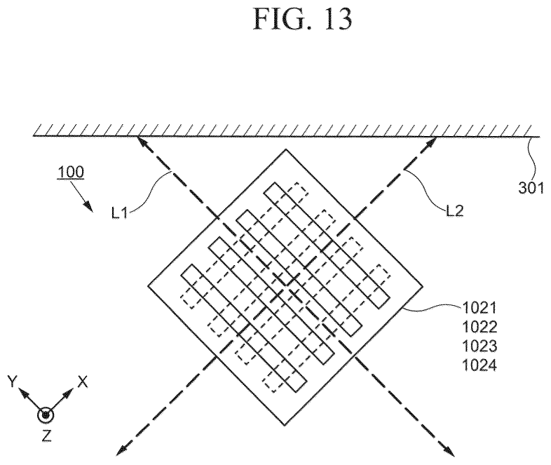

FIG. 13 shows light distribution patterns formed under the first voltage application condition and the second voltage application condition. Note that FIG. 13 shows an example in which the first to fourth liquid crystal panels 1021, 1022, 1023, and 1024 are arranged in a state of being rotated within a range of 45±10 degrees with respect to the wall surface 301. Under the first voltage application condition, a line light distribution L1 extending in the Y-axis direction is formed, and under the second voltage application condition, a line light distribution L2 extending in the X-axis direction is formed. Portions of these two-line light distributions L1 and L2 are irradiated onto the wall, but since the directions in which the distributed light beams extend are different, the irradiated positions are different. The liquid crystal light control element 100 is driven by the control circuit 206 (see FIG. 1 and FIG. 5) such that the first voltage application condition and the second voltage application condition are alternately repeated. By switching between the two voltage application conditions at a low frequency that can be followed by human vision, it is possible to create an effect as if the light irradiated onto the wall surface 301 or the ceiling 302 is flickering. In this case, the voltage application conditions may be switched at a constant period, or may be switched so as to have a 1/f fluctuation.

The lighting device 200 according to the present embodiment can form line light distributions in which light extends in two different directions by applying the liquid crystal light control element 100 using four liquid crystal panels. By alternately switching between these line light distributions, it is possible to create a decorative effect in an indoor space as indirect lighting. Furthermore, by switching the line light distributions at a predetermined or random cycle as described above, fluctuations are visualized by the diffused light irradiated onto the wall surface. In the present embodiment, the axis of the fluctuation of the diffused light (i.e., the center axis of the line light distribution) itself moves to a plurality of positions, making it possible to provide diversity to the aforementioned expression of fluctuations.

### Second Embodiment

The lighting device 200 according to the present embodiment has a configuration in which the third liquid crystal panel 1023 and the fourth liquid crystal panel 1024 constituting the liquid crystal light control element 100 are rotated relative to the first liquid crystal panel 1021 and the second liquid crystal panel 1022 in the lighting device 200 according to the first embodiment. In the following description, portions different from the first embodiment will be mainly described, and descriptions of common portions will be omitted as appropriate.

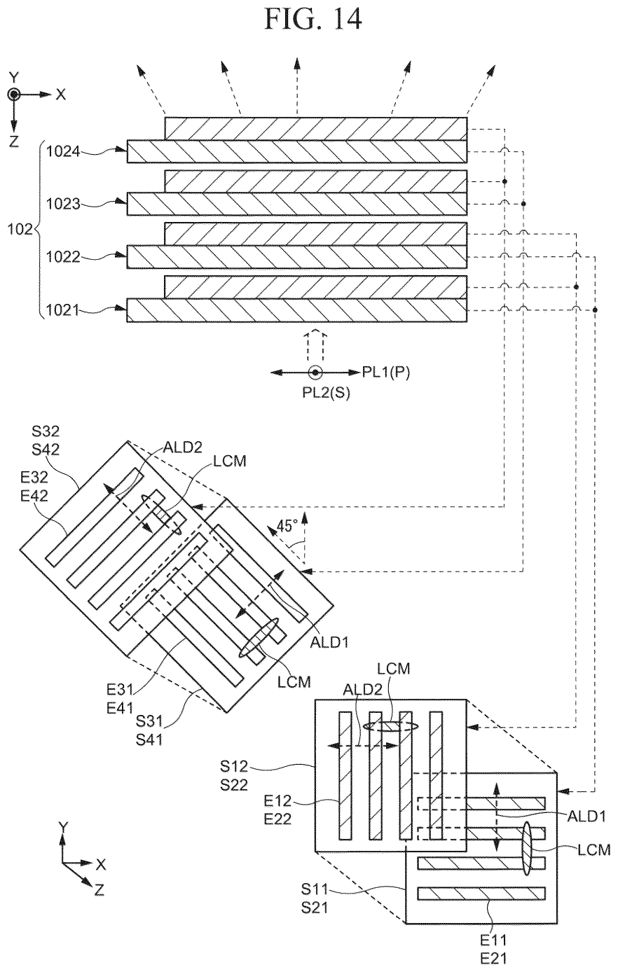

FIG. 14 shows a configuration of a liquid crystal light control element 100 according to the present embodiment. Similar to the first embodiment, the liquid crystal light control element 100 is composed of four liquid crystal panels (a first liquid crystal panel 1021, a second liquid crystal panel 1022, a third liquid crystal panel 1023, and a fourth liquid crystal panel 1024) stacked in the Z-axis direction. On the other hand, in the present embodiment, the third liquid crystal panel 1023 and the fourth liquid crystal panel 1024 are rotated within a range of 45±10 degrees relative to the first liquid crystal panel 1021 and the second liquid crystal panel 1022.

Due to such stacking of the liquid crystal panels, the extending directions of the strip patterns of the first electrodes E31 and E41 of the third and fourth liquid crystal panels 1023 and 1024 are inclined within a range of 45±10 degrees relative to the first electrodes E11 and E21 of the first and second liquid crystal panels 1021 and 1022. Similarly, the extending directions of the strip patterns of the second electrodes E32 and E42 of the third and fourth liquid crystal panels 1023 and 1024 are also inclined within a range of 45±10 degrees relative to the second electrodes E12 and E22 of the first and second liquid crystal panels 1021 and 1022. The same applies to the alignment directions ALD1 and ALD2 of the alignment films, and the alignment direction of the liquid crystal molecules LCM.

The voltage application conditions for the liquid crystal light control element 100 are shown below. In the present embodiment, there are four voltage application conditions because two of the liquid crystal panels are arranged to be rotated by 45 degrees.

Table 3 shows the first voltage application conditions in the present embodiment and the state in which polarization components are diffused in each liquid crystal panel.

TABLE 3

| | | | Alignment | Diffusion Direction |
|---|---|---|---|---|
| LC | | | Direction of | of Polarization |
| Panel | Electrode | Drive | Alignment Film | Component |
| 4 | E42 | OFF | [symbol] | Transmission |
| (+45°) | E41 | OFF | [symbol] | Transmission |
| 3 | E32 | OFF | [symbol] | Transmission |
| (+45°) | E31 | OFF | [symbol] | Transmission |
| 2 | E22 | OFF | [symbol] | Transmission |
| | E21 | ON | [symbol] | Diffusion (Y) |
| 1 | E12 | OFF | [symbol] | Transmission |
| | E11 | ON | [symbol] | Diffusion (Y) |

The first voltage application condition shown in Table 3 is a condition in which, in the first liquid crystal panel 1021 and the second liquid crystal panel 1022, the first electrodes E11 and E21 are turned ON to align liquid crystal molecules by a lateral electric field, and the second electrodes E12 and E22 are turned OFF. Regarding the third liquid crystal panel 1023 and the fourth liquid crystal panel 1024, both the first electrodes E31 and E41 and the second electrodes E32 and E42 are turned OFF. Under such conditions, of the incident light, a polarization component in the same direction as the alignment direction of the alignment films on the first substrates S11 and S21 of the first liquid crystal panel 1021 and the second liquid crystal panel 1022 is diffused in the Y-axis direction. That is, under the first voltage application condition, a line light distribution (L1) is formed in which the incident light from the light source is diffused in the Y-axis direction.

Table 4 shows the second voltage application conditions in the present embodiment and the state in which polarization components are diffused in each liquid crystal panel.

TABLE 4

| | | | Alignment | Diffusion Direction |
|---|---|---|---|---|
| LC | | | Direction of | of Polarization |
| Panel | Electrode | Drive | Alignment Film | Component |
| 4 | E42 | OFF | [symbol] | Transmission |
| (+45°) | E41 | ON | [symbol] | Diffusion (Y-45°) |
| 3 | E32 | OFF | [symbol] | Transmission |
| (+45°) | E31 | ON | [symbol] | Diffusion (Y-45°) |
| 2 | E22 | OFF | [symbol] | Transmission |
| | E21 | OFF | [symbol] | Transmission |
| 1 | E12 | OFF | [symbol] | Transmission |
| | E11 | OFF | [symbol] | Transmission |

The second voltage application condition shown in Table 4 is a condition in which, in the third liquid crystal panel 1023 and the fourth liquid crystal panel 1024, the first electrodes E31 and E41 are turned ON to align liquid crystal molecules by a lateral electric field, and the second electrodes E32 and E42 are turned OFF. Regarding the first liquid crystal panel 1021 and the second liquid crystal panel 1022, both the first electrodes E11 and E21 and the second electrodes E12 and E22 are turned OFF. Under such conditions, of the incident light, a polarization component in the same direction as the alignment direction of the alignment films on the first substrates S31 and S41 of the third liquid crystal panel 1023 and the fourth liquid crystal panel 1024 is diffused in a direction inclined by 45±10 degrees with respect to the Y-axis direction. That is, under the second voltage application condition, a line light distribution (L2) is formed in which the incident light from the light source is diffused in a direction inclined by 45 degrees with respect to the Y-axis direction. Here, the indication “Diffusion (Y−45°)” in Table 4 indicates that the light is diffused in a direction inclined clockwise by 45 degrees with respect to the Y-axis direction. This notation in the table is the same in the subsequent embodiments. Thus, in the present embodiment, the polarization components acted upon by the first and second liquid crystal panels 1021 and 1022 differ by 45 degrees from those acted upon by the third and fourth liquid crystal panels 1023 and 1024. Note that the direction in which the line light distribution (L2) extends will be within a range of 45±10 degrees with respect to the Y-axis direction, depending on the rotation angle of the liquid crystal panels.

Table 5 shows the third voltage application conditions in the present embodiment and the state in which polarization components are diffused in each liquid crystal panel.

TABLE 5

| | | | Alignment | Diffusion Direction |
|---|---|---|---|---|
| LC | | | Direction of | of Polarization |
| Panel | Electrode | Drive | Alignment Film | Component |
| 4 | E42 | OFF | [symbol] | Transmission |
| (+45°) | E41 | OFF | [symbol] | Transmission |
| 3 | E32 | OFF | [symbol] | Transmission |
| (+45°) | E31 | OFF | [symbol] | Transmission |
| 2 | E22 | ON | [symbol] | Diffusion (X) |
| | E21 | OFF | [symbol] | Transmission |
| 1 | E12 | ON | [symbol] | Diffusion (X) |
| | E11 | OFF | [symbol] | Transmission |

The third voltage application condition shown in Table 5 is a condition in which, in the first liquid crystal panel 1021 and the second liquid crystal panel 1022, the first electrodes E11 and E21 are turned OFF, and the second electrodes E12 and E22 are turned ON to align liquid crystal molecules by a lateral electric field. Regarding the third liquid crystal panel 1023 and the fourth liquid crystal panel 1024, both the first electrodes E31 and E41 and the second electrodes E32 and E42 are turned OFF. Under such conditions, of the incident light, a polarization component in the same direction as the alignment direction of the alignment films on the second substrates S12 and S22 of the first liquid crystal panel 1021 and the second liquid crystal panel 1022 is diffused in the X-axis direction. That is, under the third voltage application condition, a line light distribution (L3) is formed in which the incident light from the light source is diffused in the X-axis direction.

Table 6 shows the fourth voltage application conditions in the present embodiment and the state in which polarization components are diffused in each liquid crystal panel.

TABLE 6

| | | | Alignment | Diffusion Direction |
|---|---|---|---|---|
| LC | | | Direction of | of Polarization |
| Panel | Electrode | Drive | Alignment Film | Component |
| 4 | E42 | ON | [symbol] | Diffusion (X-45°) |
| (+45°) | E41 | OFF | [symbol] | Transmission |
| 3 | E32 | ON | [symbol] | Diffusion (X-45°) |
| (+45°) | E31 | OFF | [symbol] | Transmission |
| 2 | E22 | OFF | [symbol] | Transmission |
| | E21 | OFF | [symbol] | Transmission |
| 1 | E12 | OFF | [symbol] | Transmission |
| | E11 | OFF | [symbol] | Transmission |

The fourth voltage application condition shown in Table 6 is a condition in which, in the third liquid crystal panel 1023 and the fourth liquid crystal panel 1024, the first electrodes E31 and E41 are turned OFF, and the second electrodes E32 and E42 are turned ON to align liquid crystal molecules by a lateral electric field. Regarding the first liquid crystal panel 1021 and the second liquid crystal panel 1022, both the first electrodes E11 and E21 and the second electrodes E12 and E22 are turned OFF. Under such conditions, of the incident light, a polarization component in the same direction as the alignment direction of the alignment films on the second substrates S32 and S42 of the third liquid crystal panel 1023 and the fourth liquid crystal panel 1024 is diffused in a direction inclined by 45 degrees with respect to the X-axis direction. That is, under the fourth voltage application condition, a line light distribution (L4) is formed in which the incident light from the light source is diffused in a direction inclined by 45 degrees with respect to the X-axis direction. Note that the direction in which the line light distribution (L4) extends will be within a range of 45±10 degrees with respect to the X-axis direction, depending on the rotation angle of the liquid crystal panels.

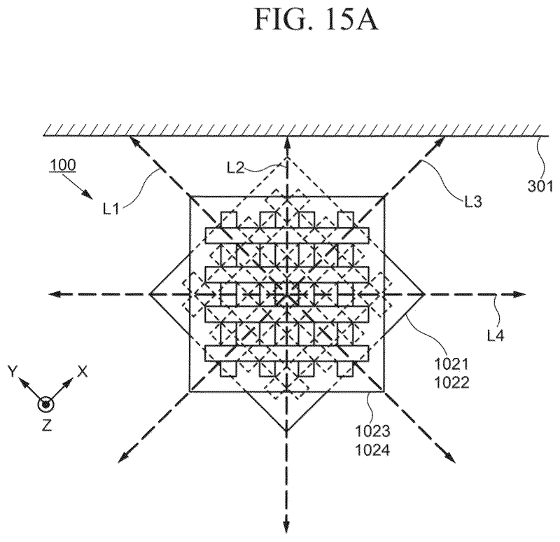

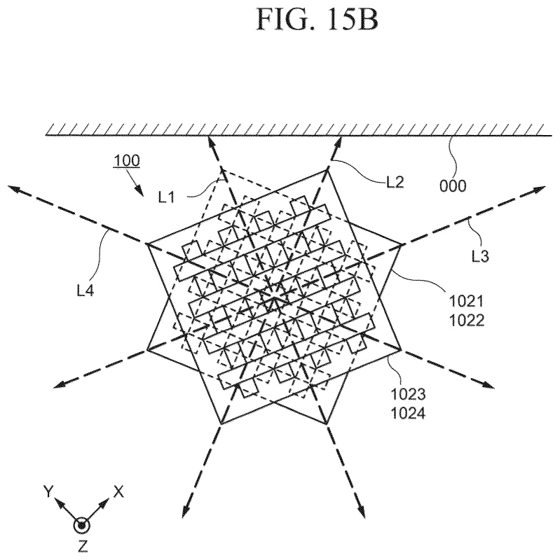

FIG. 15A shows light distribution patterns formed under the first to fourth voltage application conditions. That is, it shows the light distribution patterns formed by the line light distributions L1 to L4. Note that FIG. 15A shows a state in which the first liquid crystal panel 1021 and the second liquid crystal panel 1022 are arranged while being rotated within a range of 45±10 degrees with respect to the wall surface 301. Under the first voltage application condition, a line light distribution L1 extending in the Y-axis direction is formed; under the second voltage application condition, a line light distribution L2 extending in a direction inclined by 45 degrees with respect to the Y-axis direction is formed; under the third voltage application condition, a line light distribution L3 extending in the X-axis direction is formed; and under the fourth voltage application condition, a line light distribution L4 extending in a direction inclined by 45 degrees with respect to the X-axis direction is formed. Of these four-line light distributions L1, L2, L3, and L4, at least three-line light distributions L1, L2, and L3 are irradiated onto the wall surface 301, but their irradiation positions differ because the directions in which the distributed light beams extend are different. In this way, by arranging the third and fourth liquid crystal panels 1023 and 1024 such that they are rotated by 45±10 degrees among the first to fourth liquid crystal panels 1021, 1022, 1023, and 1024, the number of line light distributions irradiated onto the wall surface 301 can be increased. That is, as the fluctuations are visualized by the diffused light irradiated onto the wall surface 301, the axes of the fluctuations represented by the center axes of the line light distributions move to a plurality of positions, making it possible to provide diversity to the aforementioned expression of fluctuations. Note that the first to fourth voltage application conditions are driven for each liquid crystal panel as in the first embodiment, but the order of the voltage application conditions is arbitrary and is not limited to an ascending order from the first to the fourth.

FIG. 15B shows a state in which each liquid crystal panel (the first liquid crystal panel 1021, the second liquid crystal panel 1022, the third liquid crystal panel 1023, and the fourth liquid crystal panel 1024) is further rotated within a range of 22.5±10 degrees with respect to the arrangement of the liquid crystal panels shown in FIG. 15A. According to such an arrangement of the liquid crystal panels, it becomes possible to irradiate all four-line light distributions L1, L2, L3, and L4 onto the wall surface 301. Furthermore, the irradiation range of the line light distributions L1, L2, L3, and L4 emitted from the liquid crystal light control element 100 can be expanded.

In the lighting device 200 according to the present embodiment, the number of line light distributions irradiated onto the wall surface 301 or the ceiling 302 can be increased by arranging two of the four liquid crystal panels constituting the liquid crystal light control element 100 such that they are rotated within a range of 45±10 degrees. With such a configuration, it is possible to further enhance the decorative effect of an indoor space as indirect lighting.

Note that, although the present embodiment has been described assuming that the third liquid crystal panel 1023 and the fourth liquid crystal panel 1024 are rotated within a range of 45±10 degrees relative to the first liquid crystal panel 1021 and the second liquid crystal panel 1022, this relationship is relative. Therefore, it can also be interpreted that the first liquid crystal panel 1021 and the second liquid crystal panel 1022 are rotated within a range of 45±10 degrees relative to the third liquid crystal panel 1023 and the fourth liquid crystal panel 1024.

### Third Embodiment

The present embodiment shows an example of a light distribution pattern of a lighting device in which a liquid crystal light control element 100 using six liquid crystal panels is employed.

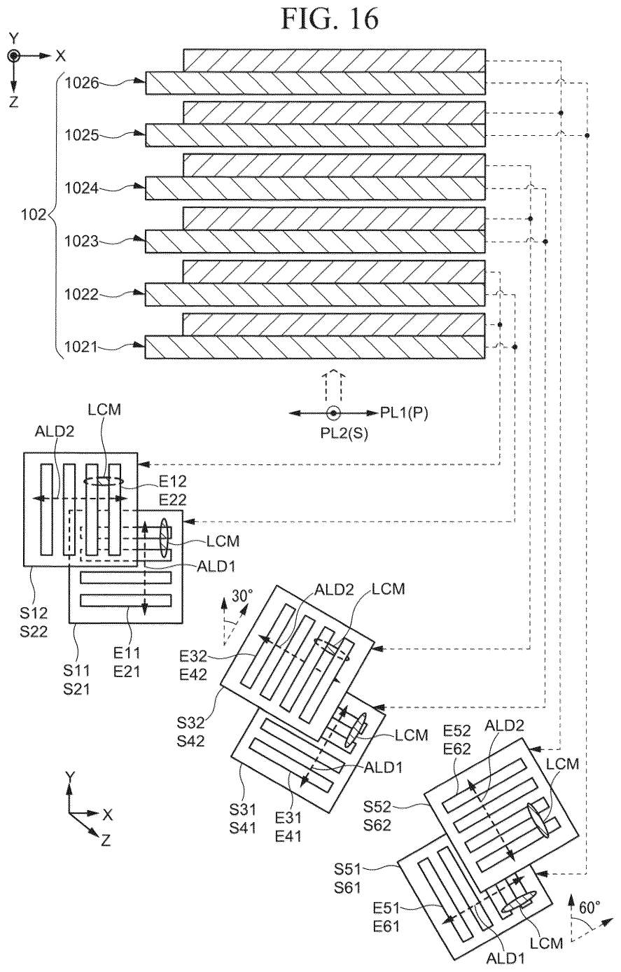

FIG. 16 shows a configuration in which a liquid crystal light control element 100 according to the present embodiment is composed of six liquid crystal panels (a first liquid crystal panel 1021, a second liquid crystal panel 1022, a third liquid crystal panel 1023, a fourth liquid crystal panel 1024, a fifth liquid crystal panel 1025, and a sixth liquid crystal panel 1026) stacked in the Z-axis direction. In the present embodiment, the third liquid crystal panel 1023 and the fourth liquid crystal panel 1024 are arranged to be rotated within a range of 30±10 degrees relative to the first liquid crystal panel 1021 and the second liquid crystal panel 1022, and the fifth liquid crystal panel 1025 and the sixth liquid crystal panel 1026 are arranged to be rotated within a range of 60±10 degrees relative to the first liquid crystal panel 1021 and the second liquid crystal panel 1022.

Due to such stacking, the extending directions of the strip patterns of the first electrodes E31 and E41 of the third and fourth liquid crystal panels 1023 and 1024 are inclined within a range of 30±10 degrees relative to the first electrodes E11 and E21 of the first and second liquid crystal panels 1021 and 1022, and the extending directions of the strip patterns of the first electrodes E51 and E61 of the fifth and sixth liquid crystal panels 1025 and 1026 are inclined within a range of 60±10 degrees relative thereto. Similarly, the extending directions of the strip patterns of the second electrodes E32 and E42 of the third and fourth liquid crystal panels 1023 and 1024 are inclined within a range of 30±10 degrees relative to the second electrodes E12 and E22 of the first and second liquid crystal panels 1021 and 1022, and the extending directions of the strip patterns of the second electrodes E52 and E62 of the fifth and sixth liquid crystal panels 1025 and 1026 are inclined within a range of 60±10 degrees relative thereto. The same applies to the alignment directions ALD1 and ALD2 of the alignment films and the alignment direction of the liquid crystal molecules LCM.

The voltage application conditions for the liquid crystal light control element 100 are shown below. In the present embodiment, there are six voltage application conditions because two of the liquid crystal panels are arranged to be rotated within a range of 30±10 degrees and another two liquid crystal panels are arranged to be rotated within a range of 60±10 degrees.

Table 7 shows the first voltage application conditions in the present embodiment and the state in which polarization components are diffused in each liquid crystal panel.

TABLE 7

| | | | Alignment | Diffusion Direction |
|---|---|---|---|---|
| LC | | | Direction of | of Polarization |
| Panel | Electrode | Drive | Alignment Film | Component |
| 6 | E62 | OFF | [symbol] | Transmission |
| (−60°) | E61 | OFF | [symbol] | Transmission |
| 5 | E52 | OFF | [symbol] | Transmission |
| (−60°) | E51 | OFF | [symbol] | Transmission |
| 4 | E42 | OFF | [symbol] | Transmission |
| (−30°) | E41 | OFF | [symbol] | Transmission |
| 3 | E32 | OFF | [symbol] | Transmission |
| (−30°) | E31 | OFF | [symbol] | Transmission |
| 2 | E22 | OFF | [symbol] | Transmission |
| | E21 | ON | [symbol] | Diffusion (Y) |
| 1 | E12 | OFF | [symbol] | Transmission |
| | E11 | ON | [symbol] | Diffusion (Y) |

The first voltage application condition shown in Table 7 is a condition in which, in the first liquid crystal panel 1021 and the second liquid crystal panel 1022, the first electrodes E11 and E21 are turned ON to align liquid crystal molecules by a lateral electric field, and the second electrodes E12 and E22 are turned OFF. Regarding the third to sixth liquid crystal panels 1023, 1024, 1025, and 1026, both the first electrodes E31, E41, E51, and E61 and the second electrodes E32, E42, E52, and E62 are turned OFF. Under such conditions, of the incident light, a polarization component in the same direction as the alignment direction of the alignment films on the first substrates S11 and S21 of the first liquid crystal panel 1021 and the second liquid crystal panel 1022 is diffused in the Y-axis direction. That is, under the first voltage application condition, a line light distribution (L1) is formed in which the incident light from the light source is diffused in the Y-axis direction.

Table 8 shows the second voltage application conditions in the present embodiment and the state in which polarization components are diffused in each liquid crystal panel.

TABLE 8

| | | | Alignment | Diffusion Direction |
|---|---|---|---|---|
| LC | | | Direction of | of Polarization |
| Panel | Electrode | Drive | Alignment Film | Component |
| 6 | E62 | OFF | [symbol] | Transmission |
| (−60°) | E61 | OFF | [symbol] | Transmission |
| 5 | E52 | OFF | [symbol] | Transmission |
| (−60°) | E51 | OFF | [symbol] | Transmission |
| 4 | E42 | OFF | [symbol] | Transmission |
| (−30°) | E41 | ON | [symbol] | Diffusion (Y-30°) |
| 3 | E32 | OFF | [symbol] | Transmission |
| (−30°) | E31 | ON | [symbol] | Diffusion (Y-30°) |
| 2 | E22 | OFF | [symbol] | Transmission |
| | E21 | OFF | [symbol] | Transmission |
| 1 | E12 | OFF | [symbol] | Transmission |
| | E11 | OFF | [symbol] | Transmission |

The second voltage application condition shown in Table 8 is a condition in which, in the third liquid crystal panel 1023 and the fourth liquid crystal panel 1024, the first electrodes E31 and E41 are turned ON to align liquid crystal molecules by a lateral electric field, and the second electrodes E32 and E42 are turned OFF. Regarding the first liquid crystal panel 1021, the second liquid crystal panel 1022, the fifth liquid crystal panel 1025, and the sixth liquid crystal panel 1026, both the first electrodes E11, E21, E51, and E61 and the second electrodes E12, E22, E52, and E62 are turned OFF. Under such conditions, of the incident light, a polarization component in the same direction as the alignment direction of the alignment films on the first substrates S31 and S41 of the third liquid crystal panel 1023 and the fourth liquid crystal panel 1024 is diffused in a direction inclined within a range of 30±10 degrees with respect to the Y-axis direction. That is, under the second voltage application condition, a line light distribution (L2) is formed in which the incident light from the light source is diffused once in a direction inclined within a range of 30±10 degrees with respect to the Y-axis direction.

Table 9 shows the third voltage application conditions in the present embodiment and the state in which polarization components are diffused in each liquid crystal panel.

TABLE 9

| | | | Alignment | Diffusion Direction |
|---|---|---|---|---|
| LC | | | Direction of | of Polarization |
| Panel | Electrode | Drive | Alignment Film | Component |
| 6 | E62 | OFF | [symbol] | Transmission |
| (−60°) | E61 | ON | [symbol] | Diffusion (Y-60°) |
| 5 | E52 | OFF | [symbol] | Transmission |
| (−60°) | E51 | ON | [symbol] | Diffusion (Y-60°) |
| 4 | E42 | OFF | [symbol] | Transmission |
| (−30°) | E41 | OFF | [symbol] | Transmission |
| 3 | E32 | OFF | [symbol] | Transmission |
| (−30°) | E31 | OFF | [symbol] | Transmission |
| 2 | E22 | OFF | [symbol] | Transmission |
| | E21 | OFF | [symbol] | Transmission |
| 1 | E12 | OFF | [symbol] | Transmission |
| | E11 | OFF | [symbol] | Transmission |

The third voltage application condition shown in Table 9 is a condition in which, in the fifth liquid crystal panel 1025 and the sixth liquid crystal panel 1026, the first electrodes E51 and E61 are turned ON to align liquid crystal molecules by a lateral electric field, and the second electrodes E52 and E62 are turned OFF. Regarding the first to fourth liquid crystal panels 1021, 1022, 1023, and 1024, both the first electrodes E11, E21, E31, and E41 and the second electrodes E12, E22, E32, and E42 are turned OFF. Under such conditions, of the incident light, a polarization component in the same direction as the alignment direction of the alignment films on the first substrates S51 and S61 of the fifth liquid crystal panel 1025 and the sixth liquid crystal panel 1026 is diffused in a direction inclined within a range of 60±10 degrees with respect to the Y-axis direction. That is, under the third voltage application condition, a line light distribution (L3) is formed in which the incident light from the light source is diffused once in a direction inclined within a range of 60±10 degrees with respect to the Y-axis direction.

Table 10 shows the fourth voltage application conditions in the present embodiment and the state in which polarization components are diffused in each liquid crystal panel.

TABLE 10

| | | | Alignment | Diffusion Direction |
|---|---|---|---|---|
| LC | | | Direction of | of Polarization |
| Panel | Electrode | Drive | Alignment Film | Component |
| 6 | E62 | OFF | [symbol] | Transmission |
| (−60°) | E61 | OFF | [symbol] | Transmission |
| 5 | E52 | OFF | [symbol] | Transmission |
| (−60°) | E51 | OFF | [symbol] | Transmission |
| 4 | E42 | OFF | [symbol] | Transmission |
| (−30°) | E41 | OFF | [symbol] | Transmission |
| 3 | E32 | OFF | [symbol] | Transmission |
| (−30°) | E31 | OFF | [symbol] | Transmission |
| 2 | E22 | ON | [symbol] | Diffusion (X) |
| | E21 | OFF | [symbol] | Transmission |
| 1 | E12 | ON | [symbol] | Diffusion (X) |
| | E11 | OFF | [symbol] | Transmission |

The fourth voltage application condition shown in Table 10 is a condition in which, in the first liquid crystal panel 1021 and the second liquid crystal panel 1022, the second electrodes E12 and E22 are turned ON to align liquid crystal molecules by a lateral electric field, and the first electrodes E11 and E21 are turned OFF. Regarding the third to sixth liquid crystal panels 1023, 1024, 1025, and 1026, both the first electrodes E31, E41, E51, and E61 and the second electrodes E32, E42, E52, and E62 are turned OFF. Under such conditions, of the incident light, a polarization component in the same direction as the alignment direction of the alignment films on the second substrates S12 and S22 of the first liquid crystal panel 1021 and the second liquid crystal panel 1022 is diffused in the X-axis direction. That is, under the fourth voltage application condition, a line light distribution (L4) is formed in which the incident light from the light source is diffused once in the X-axis direction.

Table 11 shows the fifth voltage application conditions in the present embodiment and the state in which polarization components are diffused in each liquid crystal panel.

TABLE 11

| | | | Alignment | Diffusion Direction |
|---|---|---|---|---|
| LC | | | Direction of | of Polarization |
| Panel | Electrode | Drive | Alignment Film | Component |
| 6 | E62 | OFF | [symbol] | Transmission |
| (−60°) | E61 | OFF | [symbol] | Transmission |
| 5 | E52 | OFF | [symbol] | Transmission |
| (−60°) | E51 | OFF | [symbol] | Transmission |
| 4 | E42 | ON | [symbol] | Diffusion (X-30°) |
| (−30°) | E41 | OFF | [symbol] | Transmission |
| 3 | E32 | ON | [symbol] | Diffusion (X-30°) |
| (−30°) | E31 | OFF | [symbol] | Transmission |
| 2 | E22 | OFF | [symbol] | Transmission |
| | E21 | OFF | [symbol] | Transmission |
| 1 | E12 | OFF | [symbol] | Transmission |
| | E11 | OFF | [symbol] | Transmission |

The fifth voltage application condition shown in Table 11 is a condition in which, in the third liquid crystal panel 1023 and the fourth liquid crystal panel 1024, the second electrodes E32 and E42 are turned ON to align liquid crystal molecules by a lateral electric field, and the first electrodes E31 and E41 are turned OFF. Regarding the first liquid crystal panel 1021, the second liquid crystal panel 1022, the fifth liquid crystal panel 1025, and the sixth liquid crystal panel 1026, both the first electrodes E11, E21, E51, and E61 and the second electrodes E12, E22, E52, and E62 are turned OFF. Under such conditions, of the incident light, a polarization component in the same direction as the alignment direction of the alignment films on the second substrates S32 and S42 of the third liquid crystal panel 1023 and the fourth liquid crystal panel 1024 is diffused in a direction inclined within a range of 30±10 degrees with respect to the X-axis direction. That is, under the fifth voltage application condition, a line light distribution (L5) is formed in which the incident light from the light source is diffused once in a direction inclined within a range of 30±10 degrees with respect to the X-axis direction.

Table 12 shows the sixth voltage application conditions in the present embodiment and the state in which polarization components are diffused in each liquid crystal panel.

TABLE 12

| | | | Alignment | Diffusion Direction |
|---|---|---|---|---|
| LC | | | Direction of | of Polarization |
| Panel | Electrode | Drive | Alignment Film | Component |
| 6 | E62 | ON | [symbol] | Diffusion (X-60°) |
| (−60°) | E61 | OFF | [symbol] | Transmission |
| 5 | E52 | ON | [symbol] | Diffusion (X-60°) |
| (−60°) | E51 | OFF | [symbol] | Transmission |
| 4 | E42 | OFF | [symbol] | Transmission |
| (−30°) | E41 | OFF | [symbol] | Transmission |
| 3 | E32 | OFF | [symbol] | Transmission |
| (−30°) | E31 | OFF | [symbol] | Transmission |
| 2 | E22 | OFF | [symbol] | Transmission |
| | E21 | OFF | [symbol] | Transmission |
| 1 | E12 | OFF | [symbol] | Transmission |
| | E11 | OFF | [symbol] | Transmission |

The sixth voltage application condition shown in Table 12 is a condition in which, in the fifth liquid crystal panel 1025 and the sixth liquid crystal panel 1026, the second electrodes E52 and E62 are turned ON to align liquid crystal molecules by a lateral electric field, and the first electrodes E51 and E61 are turned OFF. Regarding the first to fourth liquid crystal panels 1021, 1022, 1023, and 1024, both the first electrodes E11, E21, E31, and E41 and the second electrodes E12, E22, E32, and E42 are turned OFF. Under such conditions, of the incident light, a polarization component in the same direction as the alignment direction of the alignment films on the second substrates S52 and S62 of the fifth liquid crystal panel 1025 and the sixth liquid crystal panel 1026 is diffused in a direction inclined within a range of 60±10 degrees with respect to the X-axis direction. That is, under the sixth voltage application condition, a line light distribution (L6) is formed in which the incident light from the light source is diffused once in a direction inclined within a range of 60±10 degrees with respect to the X-axis direction.

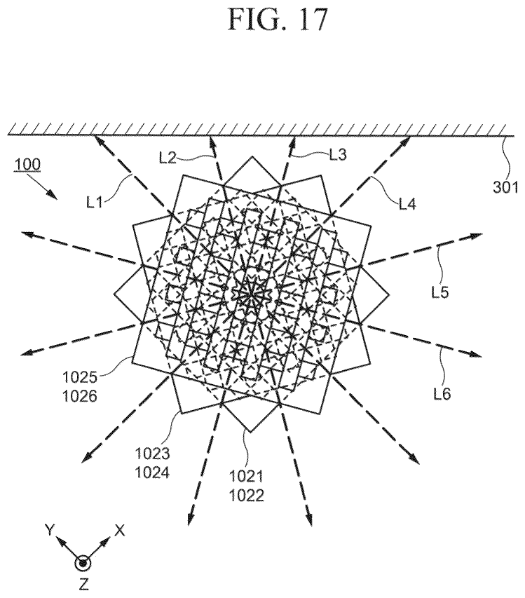

FIG. 17 shows light distribution patterns formed under the first to sixth voltage application conditions. Note that FIG. 17 shows an example in which the first liquid crystal panel 1021 and the second liquid crystal panel 1022 are arranged in a state of being rotated within a range of 45±10 degrees with respect to the wall surface 301. Along with this arrangement, the third liquid crystal panel 1023 and the fourth liquid crystal panel 1024 are arranged to be further rotated within a range of 30±10 degrees relative to the first liquid crystal panel 1021 and the second liquid crystal panel 1022, and the fifth liquid crystal panel 1025 and the sixth liquid crystal panel 1026 are arranged to be further rotated within a range of 60±10 degrees relative thereto. Under the first voltage application condition, a line light distribution L1 extending in the Y-axis direction is formed; under the second voltage application condition, a line light distribution L2 extending in a direction inclined within a range of 30±10 degrees with respect to the Y-axis direction is formed; and under the third voltage application condition, a line light distribution L3 extending in a direction inclined within a range of 60±10 degrees with respect to the Y-axis direction is formed. Furthermore, under the fourth voltage application condition, a line light distribution L4 extending in the X-axis direction is formed; under the fifth voltage application condition, a line light distribution L5 extending in a direction inclined within a range of 30±10 degrees with respect to the X-axis direction is formed; and under the sixth voltage application condition, a line light distribution L6 extending in a direction inclined within a range of 60±10 degrees with respect to the X-axis direction is formed.

Among the six-line light distributions L1, L2, L3, L4, L5, and L6, at least four-line light distributions L1, L2, L3, and L4 are irradiated onto the wall surface 301. Since the directions in which the distributed light beams extend are different, a larger number of light irradiation regions can be formed compared to the second embodiment. In this way, the number of line light distributions irradiated onto the wall surface 301 can be increased by arranging the third and fourth liquid crystal panels 1023 and 1024 to be rotated within a range of 30±10 degrees and further arranging the fifth and sixth liquid crystal panels 1025 and 1026 to be rotated within a range of 60±10 degrees among the first to sixth liquid crystal panels 1021, 1022, 1023, 1024, 1025, and 1026. Note that the first to sixth voltage application conditions are driven for each liquid crystal panel as in the first embodiment, but the order of the voltage application conditions is arbitrary; the voltage can be applied in any order and is not limited to an ascending order from the first to the sixth.

The lighting device 200 according to the present embodiment is arranged so that two liquid crystal panels are rotated within a range of 30±10 degrees and the other two liquid crystal panels are rotated within a range of 60±10 degrees among the six liquid crystal panels constituting the liquid crystal light control element 100, thereby increasing the number of line light distributions irradiated to the wall surface 301 and the ceiling 302. With such a configuration, it is possible to further enhance the decorative effect of an indoor space as indirect lighting.

### Fourth Embodiment

The lighting device 200 according to the present embodiment shows an example in which the configuration of the electrodes of the liquid crystal panel constituting the liquid crystal light control element 100 is different from that of the first embodiment. Specifically, while the strip patterns of the first electrode and the second electrode of the liquid crystal panel are orthogonal to each other in the first embodiment, the first electrode and the second electrode of the liquid crystal panel are arranged to intersect at an angle of 45±10 degrees in the present embodiment.

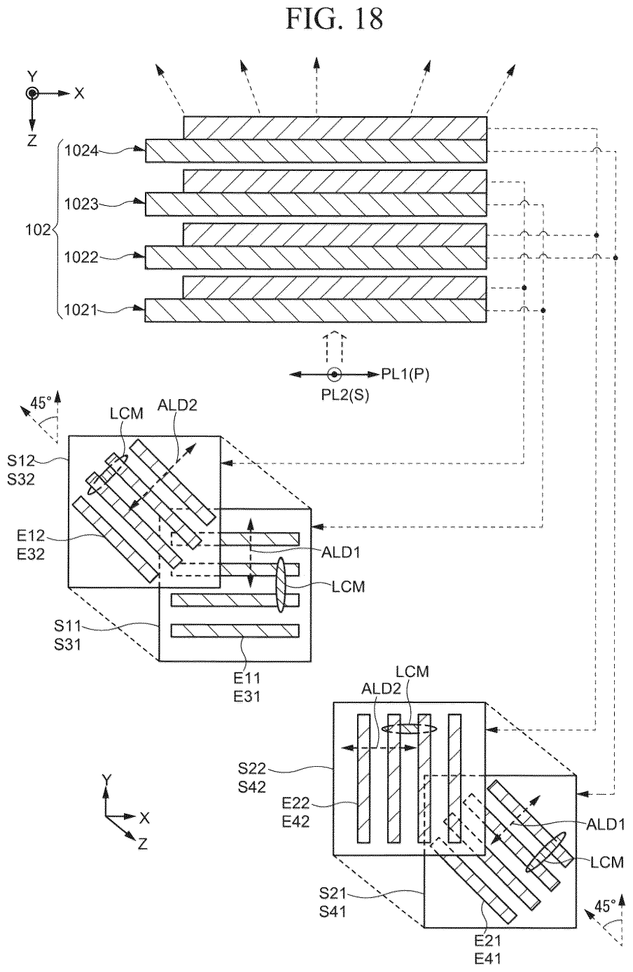

FIG. 18 shows the configuration of a liquid crystal light control element 100 according to the present embodiment. The liquid crystal light control element 100 is composed of four liquid crystal panels (a first liquid crystal panel 1021, a second liquid crystal panel 1022, a third liquid crystal panel 1023, and a fourth liquid crystal panel 1024) stacked in the Z-axis direction, which is similar to the first embodiment. On the other hand, the present embodiment differs from the first embodiment in that the second electrodes E12 and E32 of the first liquid crystal panel 1021 and the third liquid crystal panel 1023 are arranged to be rotated within a range of 45±10 degrees relative to the first electrodes E11 and E31, and the first electrodes E21 and E41 of the second liquid crystal panel 1022 and the fourth liquid crystal panel 1024 are rotated within a range of 45±10 degrees relative to the second electrodes E22 and E42.

As shown in FIG. 18, the alignment directions ALD1 and ALD2 of the alignment films also intersect at an angle of 45±10 degrees. Therefore, the angle by which the first polarization component PL1 and the second polarization component PL2 are optically rotated when passing through each liquid crystal panel is within a range of 45±10 degrees. The voltage application conditions when using such liquid crystal panels are shown in Tables 13 to 15 below.

Table 13 shows the first voltage application conditions according to the present embodiment and the state in which polarization components are diffused in each liquid crystal panel.

TABLE 13

| | | | Alignment | Diffusion Direction |
|---|---|---|---|---|
| LC | | | Direction of | of Polarization |
| Panel | Electrode | Drive | Alignment Film | Component |
| 4 | E42 | OFF | [symbol] | Transmission |
| (+45°) | E41 (+45°) | OFF | [symbol] | Transmission |
| 3 | E32 (+45°) | OFF | [symbol] | Transmission |
| | E31 | ON | [symbol] | Diffusion (Y) |
| 2 | E22 | OFF | [symbol] | Transmission |
| (+45°) | E21 (+45°) | OFF | [symbol] | Transmission |
| 1 | E12 (+45°) | OFF | [symbol] | Transmission |
| | E11 | ON | [symbol] | Diffusion (Y) |

The first voltage application condition shown in Table 13 is a condition in which, in the first liquid crystal panel 1021 and the third liquid crystal panel 1023, the first electrodes E11 and E31 are turned ON to align liquid crystal molecules by a lateral electric field, and the second electrodes E12 and E32 are turned OFF. Regarding the second liquid crystal panel 1022 and the fourth liquid crystal panel 1024, both the first electrodes E21 and E41 and the second electrodes E22 and E42 are turned OFF. Under such conditions, incident light is diffused in the Y-axis direction by the first electrode E11 of the first liquid crystal panel 1021, and is also diffused in the Y-axis direction by the first electrode E31 of the third liquid crystal panel 1023. That is, under the first voltage application condition, a line light distribution (L1) is formed in which the incident light from the light source is diffused in the Y-axis direction.

Table 14 shows the second voltage application conditions according to the present embodiment and the state in which polarization components are diffused in each liquid crystal panel.

TABLE 14

| | | | Alignment | Diffusion Direction |
|---|---|---|---|---|
| LC | | | Direction of | of Polarization |
| Panel | Electrode | Drive | Alignment Film | Component |
| 4 | E42 | OFF | [symbol] | Transmission |
| (+45°) | E41 (+45°) | ON | [symbol] | Diffusion (Y-45°) |
| 3 | E32 (+45°) | ON | [symbol] | Diffusion (Y-45°) |
| | E31 | OFF | [symbol] | Transmission |
| 2 | E22 | OFF | [symbol] | Transmission |
| (+45°) | E21 (+45°) | ON | [symbol] | Diffusion (Y-45°) |
| 1 | E12 (+45°) | ON | [symbol] | Diffusion (Y-45°) |
| | E11 | OFF | [symbol] | Transmission |

The second voltage application condition shown in Table 14 is a condition in which: in the first liquid crystal panel 1021 and the third liquid crystal panel 1023, the second electrodes E12 and E32 are turned ON to align liquid crystal molecules by a lateral electric field while the first electrodes E11 and E31 are turned OFF; and in the second liquid crystal panel 1022 and the fourth liquid crystal panel 1024, the first electrodes E21 and E41 are turned ON to align liquid crystal molecules by a lateral electric field while the second electrodes E22 and E42 are turned OFF. Under such conditions, of the incident light, polarization components in the same direction as the alignment directions of the alignment films on the second substrates S12 and S32 of the first and third liquid crystal panels 1021 and 1023, and on the first substrates S21 and S41 of the second and fourth liquid crystal panels 1022 and 1024, are diffused in a direction inclined by 45 degrees with respect to the Y-axis direction. That is, a line light distribution (L2) is formed in which the incident light from the light source is diffused in a direction inclined by 45 degrees with respect to the Y-axis direction. Note that the direction in which the line light distribution (L2) extends within a range of 45±10 degrees with respect to the Y-axis direction, depending on the rotation angle of the liquid crystal panels.

Table 15 shows the third voltage application conditions according to the present embodiment and the state in which polarization components are diffused in each liquid crystal panel.

TABLE 15

| | | | Alignment | Diffusion Direction |
|---|---|---|---|---|
| LC | | | Direction of | of Polarization |
| Panel | Electrode | Drive | Alignment Film | Component |
| 4 | E42 | ON | [symbol] | Diffusion (X) |
| (+45°) | E41 (+45°) | OFF | [symbol] | Transmission |
| 3 | E32 (+45°) | OFF | [symbol] | Transmission |
| | E31 | OFF | [symbol] | Transmission |
| 2 | E22 | ON | [symbol] | Diffusion (X) |
| (+45°) | E21 (+45°) | OFF | [symbol] | Transmission |
| 1 | E12 (+45°) | OFF | [symbol] | Transmission |
| | E11 | OFF | [symbol] | Transmission |

The third voltage application condition shown in Table 15 is a condition in which, in the second liquid crystal panel 1022 and the fourth liquid crystal panel 1024, the second electrodes E22 and E42 are turned ON to align liquid crystal molecules by a lateral electric field, and the first electrodes E21 and E41 are turned OFF. Regarding the first liquid crystal panel 1021 and the third liquid crystal panel 1023, both the first electrodes E11 and E31 and the second electrodes E12 and E32 are turned OFF. Under such conditions, of the incident light, a polarization component in the same direction as the alignment direction of the alignment films on the second substrates S22 and S42 of the second liquid crystal panel 1022 and the fourth liquid crystal panel 1024 is diffused in the X-axis direction. That is, under the third voltage application condition, a line light distribution (L3) is formed in which the incident light from the light source is diffused in the X-axis direction.

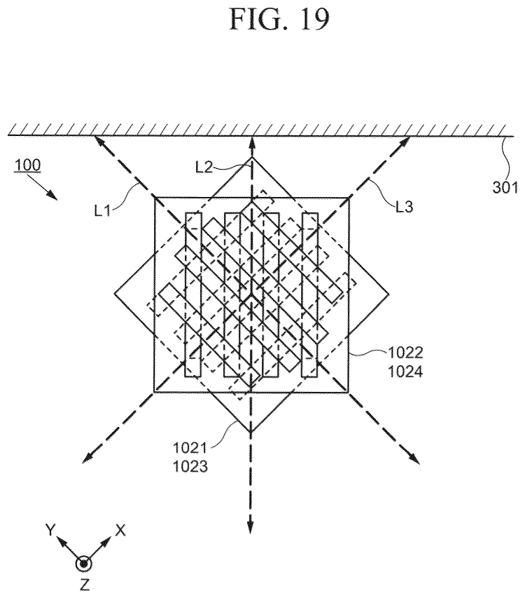

FIG. 19 shows light distribution patterns formed under the first to third voltage application conditions. Note that FIG. 19 shows a state in which the first liquid crystal panel 1021 and the third liquid crystal panel 1023 are arranged while being rotated within a range of 45±10 degrees with respect to the wall surface 301, and the second liquid crystal panel 1022 and the fourth liquid crystal panel 1024 are arranged while being rotated within a range of 45±10 degrees relative to the first liquid crystal panel 1021 and the third liquid crystal panel 1023. Under the first voltage application condition, a line light distribution L1 extending in the Y-axis direction is formed; under the second voltage application condition, a line light distribution L2 extending in a direction inclined within a range of 45±10 degrees with respect to the Y-axis direction is formed; and under the third voltage application condition, a line light distribution L3 extending in the X-axis direction is formed. These three line light distributions L1, L2, and L3 are irradiated onto the wall surface 301, and since the directions in which the distributed light beams extend are different, the irradiated positions are different. In this way, by arranging the first and third liquid crystal panels 1021 and 1023, among the first to fourth liquid crystal panels 1021, 1022, 1023, and 1024 configured such that the extending directions of the strip electrodes of the first and second electrodes intersect at an angle of 45±10 degrees, to be rotated within a range of 45±10 degrees, three line light distributions can be formed and irradiated onto the wall surface 301. Note that the first to third voltage application conditions are driven for each liquid crystal panel as in the first embodiment, but the order of the voltage application conditions is arbitrary, and there is no limitation on the order in which the first to third voltage application conditions appear.

The lighting device 200 according to the present embodiment is arranged such that the strip pattern of the first electrode and the second electrode of the liquid crystal panel constituting the liquid crystal light control element 100 intersects at an angle of 45 degrees. By stacking four such liquid crystal panels and arranging the second liquid crystal panel 1022 and the fourth liquid crystal panel 1024 to be rotated by 45 degrees relative to the first liquid crystal panel 1021 and the third liquid crystal panel 1023, line light distributions extending in three directions can be formed. With such a configuration as well, it is possible to enhance the decorative effect of an indoor space as indirect lighting.

### Fifth Embodiment

The present embodiment shows an example of a light distribution pattern of the lighting device 200 obtained by a configuration in which the electrode structure of a liquid crystal light control element 100 using six liquid crystal panels is different from that of the third embodiment.

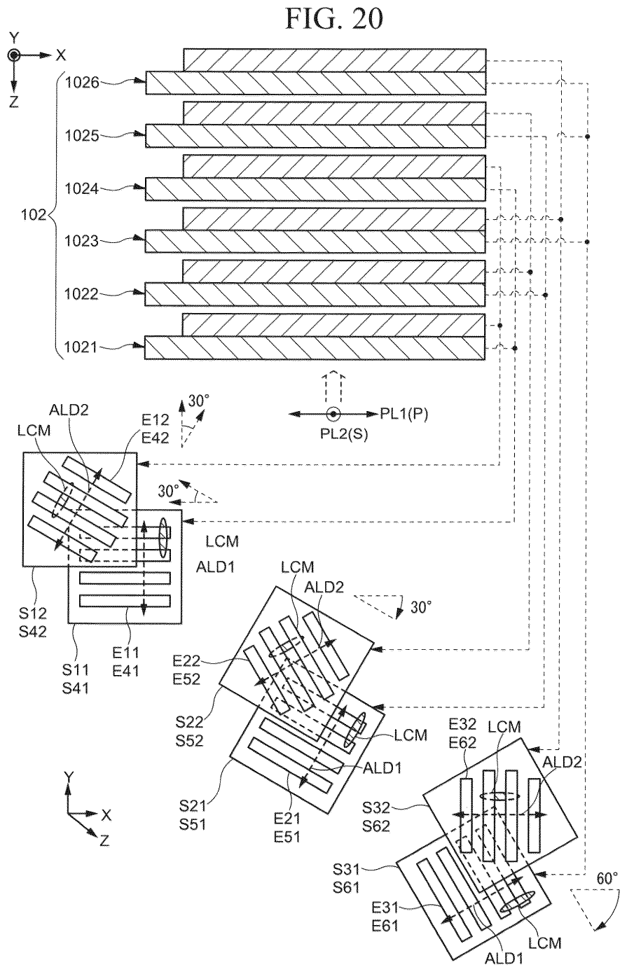

FIG. 20 shows a configuration in which a liquid crystal light control element 100 according to the present embodiment is composed of six liquid crystal panels (a first liquid crystal panel 1021, a second liquid crystal panel 1022, a third liquid crystal panel 1023, a fourth liquid crystal panel 1024, a fifth liquid crystal panel 1025, and a sixth liquid crystal panel 1026) stacked in the Z-axis direction.

The first liquid crystal panel 1024 is arranged such that the direction in which the strip electrode of the second electrode E12 extends intersects the direction in which the strip electrode of the first electrode E11 extends at an angle of 30±10 degrees. The second to sixth liquid crystal panels 1022, 1023, 1024, 1025, and 1026 also have a similar configuration. Further, the second liquid crystal panel 1022 is arranged to be rotated within a range of 30±10 degrees relative to the first liquid crystal panel 1021, and the third liquid crystal panel 1023 is arranged to be rotated within a range of 30±10 degrees relative to the second liquid crystal panel 1022 (the third liquid crystal panel 1023 is arranged to be rotated within a range of 60±10 degrees relative to the first liquid crystal panel 1021). Similarly, the fifth liquid crystal panel 1025 is arranged to be rotated within a range of 30±10 degrees relative to the fourth liquid crystal panel 1024, and the sixth liquid crystal panel 1026 is arranged to be rotated within a range of 30±10 degrees relative to the fifth liquid crystal panel 1025 (the sixth liquid crystal panel 1026 is arranged to be rotated within a range of 60±10 degrees relative to the fourth liquid crystal panel 1024). Note that the first liquid crystal panel 1021 and the fourth liquid crystal panel 1024 are arranged such that the strip electrodes of the first electrodes E11 and E41 and the strip electrodes of the second electrodes E12 and E42 extend in the same directions, respectively.

With such an arrangement, the extending directions of the strip electrodes of the first electrodes E21 and E51 of the second and fifth liquid crystal panels 1022 and 1025 are inclined within a range of 30±10 degrees relative to the first electrodes E11 and E41 of the first and fourth liquid crystal panels 1021 and 1024, and the extending directions of the strip electrodes of the first electrodes E31 and E61 of the third and sixth liquid crystal panels 1023 and 1026 are inclined within a range of 60±10 degrees. Similarly, the extending directions of the strip electrodes of the second electrodes E22 and E52 of the second and fifth liquid crystal panels 1022 and 1025 are inclined within a range of 30±10 degrees relative to the second electrodes E12 and E42 of the first and fourth liquid crystal panels 1021 and 1024, and the extending directions of the strip electrodes of the second electrodes E32 and E62 of the third and sixth liquid crystal panels 1023 and 1026 are inclined within a range of 30±10 degrees. The same applies to the alignment directions ALD1 and ALD2 of the alignment films and the alignment directions of the liquid crystal molecules LCM.

Table 16 shows the first voltage application conditions according to the present embodiment and the state in which polarization components are diffused in each liquid crystal panel.

TABLE 16

| | | | Alignment | Diffusion Direction |
|---|---|---|---|---|
| LC | | | Direction of | of Polarization |
| Panel | Electrode | Drive | Alignment Film | Component |
| 6 | E62(Y) | OFF | [symbol] | Transmission |
| (X-60°) | E61(X-60°) | OFF | [symbol] | Transmission |
| 5 | E52(X-60°) | OFF | [symbol] | Transmission |
| (X-30°) | E51(X-30°) | OFF | [symbol] | Transmission |
| 4 | E42(X-30°) | OFF | [symbol] | Transmission |
| | E41(X) | ON | [symbol] | Diffusion (Y) |
| 3 | E32(Y) | OFF | [symbol] | Transmission |
| (X-60°) | E31(X-60°) | OFF | [symbol] | Transmission |
| 2 | E22(X-60°) | OFF | [symbol] | Transmission |
| (X-30°) | E21(X-30°) | OFF | [symbol] | Transmission |
| 1 | E12(X-30°) | OFF | [symbol] | Transmission |
| | E11(X) | ON | [symbol] | Diffusion (Y) |

The first voltage application condition shown in Table 16 is a condition in which, in the first liquid crystal panel 1021 and the fourth liquid crystal panel 1024, the first electrodes E11 and E41 are turned ON to align liquid crystal molecules by a lateral electric field, and the second electrodes E12 and E42 are turned OFF. Regarding the second liquid crystal panel 1022, the third liquid crystal panel 1023, the fifth liquid crystal panel 1025, and the sixth liquid crystal panel 1026, both the first electrodes E21, E31, E51, and E61 and the second electrodes E22, E32, E52, and E62 are turned OFF. Under such conditions, of the incident light, a polarization component in the same direction as the alignment direction of the alignment films on the first substrates S11 and S41 of the first liquid crystal panel 1021 and the fourth liquid crystal panel 1024 is diffused in the Y-axis direction. That is, under the first voltage application condition, a line light distribution (L1) is formed in which the incident light from the light source is diffused in the Y-axis direction.

Table 17 shows the second voltage application conditions according to the present embodiment and the state in which polarization components are diffused in each liquid crystal panel.

TABLE 17

| | | | Alignment | Diffusion Direction |
|---|---|---|---|---|
| LC | | | Direction of | of Polarization |
| Panel | Electrode | Drive | Alignment Film | Component |
| 6 | E62(Y) | ON | [symbol] | Diffusion (X) |
| (X-60°) | E61(X-60°) | OFF | [symbol] | Transmission |
| 5 | E52(X-60°) | OFF | [symbol] | Transmission |
| (X-30°) | E51(X-30°) | OFF | [symbol] | Transmission |
| 4 | E42(X-30°) | OFF | [symbol] | Transmission |
| | E41(X) | OFF | [symbol] | Transmission |
| 3 | E32(Y) | ON | [symbol] | Diffusion (X) |
| (X-60°) | E31(X-60°) | OFF | [symbol] | Transmission |
| 2 | E22(X-60°) | OFF | [symbol] | Transmission |
| (X-30°) | E21(X-30°) | OFF | [symbol] | Transmission |
| 1 | E12(X-30°) | OFF | [symbol] | Transmission |
| | E11(X) | OFF | [symbol] | Transmission |

The second voltage application condition shown in Table 17 is a condition in which, in the third liquid crystal panel 1023 and the sixth liquid crystal panel 1026, the second electrodes E32 and E62 are turned ON to align liquid crystal molecules by a lateral electric field, and the first electrodes E31 and E61 are turned OFF. Regarding the first liquid crystal panel 1021, the second liquid crystal panel 1022, the fourth liquid crystal panel 1024, and the fifth liquid crystal panel 1025, both the first electrodes E11, E21, E41, and E51 and the second electrodes E12, E22, E42, and E52 are turned OFF. Under such conditions, of the incident light, a polarization component in the same direction as the alignment direction of the alignment films on the second substrates S32 and S62 of the third liquid crystal panel 1023 and the fourth liquid crystal panel 1024 is diffused in the X-axis direction. That is, under the second voltage application condition, a line light distribution (L2) is formed in which the incident light from the light source is diffused in the X-axis direction.

Table 18 shows the third voltage application conditions according to the present embodiment and the state in which polarization components are diffused in each liquid crystal panel.

TABLE 18

| | | | Alignment | Diffusion Direction |
|---|---|---|---|---|
| LC | | | Direction of | of Polarization |
| Panel | Electrode | Drive | Alignment Film | Component |
| 6 | E62(Y) | OFF | [symbol] | Transmission |
| (X-60°) | E61(X-60°) | OFF | [symbol] | Transmission |
| 5 | E52(X-60°) | OFF | [symbol] | Transmission |
| (X-30°) | E51(X-30°) | ON | [symbol] | Diffusion (Y-30°) |
| 4 | E42(X-30°) | ON | [symbol] | Diffusion (Y-30°) |
| | E41(X) | OFF | [symbol] | Transmission |
| 3 | E32(Y) | OFF | [symbol] | Transmission |
| (X-60°) | E31(X-60°) | OFF | [symbol] | Transmission |
| 2 | E22(X-60°) | OFF | [symbol] | Transmission |
| (X-30°) | E21(X-30°) | ON | [symbol] | Diffusion (Y-30°) |
| 1 | E12(X-30°) | ON | [symbol] | Diffusion (Y-30°) |
| | E11(X) | OFF | [symbol] | Transmission |

The third voltage application condition shown in Table 18 is a condition in which: in the first liquid crystal panel 1021 and the fourth liquid crystal panel 1024, the second electrodes E12 and E42 are turned ON to align liquid crystal molecules by a lateral electric field while the first electrodes E11 and E41 are turned OFF; and in the second liquid crystal panel 1022 and the fifth liquid crystal panel 1025, the first electrodes E21 and E51 are turned ON to align liquid crystal molecules by a lateral electric field while the second electrodes E22 and E52 are turned OFF. Regarding the third liquid crystal panel 1023 and the sixth liquid crystal panel 1026, both the first electrodes E31 and E61 and the second electrodes E32 and E62 are turned OFF. Under such conditions, a polarization component in the same direction as the alignment direction of the alignment films on the second substrates S12 and S42 of the first liquid crystal panel 1021 and the fourth liquid crystal panel 1024 is diffused in a direction of 30±10 degrees with respect to the Y-axis direction, and a polarization component in the same direction as the alignment direction of the alignment films on the first substrates S21 and S51 of the second liquid crystal panel 1022 and the fifth liquid crystal panel 1025 is diffused in a direction of 30±10 degrees with respect to the Y-axis direction. That is, under the third voltage application condition, a line light distribution (L3) is formed in which the incident light from the light source is diffused in a direction of 30±10 degrees with respect to the Y-axis direction.

Table 19 shows the fourth voltage application conditions according to the present embodiment and the state in which polarization components are diffused in each liquid crystal panel.

TABLE 19

| | | | Alignment | Diffusion Direction |
|---|---|---|---|---|
| LC | | | Direction of | of Polarization |
| Panel | Electrode | Drive | Alignment Film | Component |
| 6 | E62(Y) | OFF | [symbol] | Transmission |
| (X-60°) | E61(X-60°) | ON | [symbol] | Diffusion (Y-60°) |
| 5 | E52(X-60°) | ON | [symbol] | Diffusion (Y-60°) |
| (X-30°) | E51(X-30°) | OFF | [symbol] | Transmission |
| 4 | E42(X-30°) | OFF | [symbol] | Transmission |
| | E41(X) | OFF | [symbol] | Transmission |
| 3 | E32(Y) | OFF | [symbol] | Transmission |
| (X-60°) | E31(X-60°) | ON | [symbol] | Diffusion (Y-60°) |
| 2 | E22(X-60°) | ON | [symbol] | Diffusion (Y-60°) |
| (X-30°) | E21(X-30°) | OFF | [symbol] | Transmission |
| 1 | E12(X-30°) | OFF | [symbol] | Transmission |
| | E11(X) | OFF | [symbol] | Transmission |

The fourth voltage application condition shown in Table 19 is a condition in which: in the second liquid crystal panel 1022 and the fifth liquid crystal panel 1025, the second electrodes E22 and E52 are turned ON to align liquid crystal molecules by a lateral electric field while the first electrodes E21 and E51 are turned OFF; and in the third liquid crystal panel 1023 and the sixth liquid crystal panel 1026, the first electrodes E31 and E61 are turned ON to align liquid crystal molecules by a lateral electric field while the second electrodes E32 and E62 are turned OFF. Regarding the first liquid crystal panel 1021 and the fourth liquid crystal panel 1024, both the first electrodes E11 and E41 and the second electrodes E12 and E42 are turned OFF. Under such conditions, a polarization component in the same direction as the alignment direction of the alignment films on the second substrates S22 and S52 of the second liquid crystal panel 1022 and the fifth liquid crystal panel 1025 is diffused in a direction of 60±10 degrees with respect to the Y-axis direction, and a polarization component in the same direction as the alignment direction of the alignment films on the first substrates S31 and S61 of the third liquid crystal panel 1023 and the sixth liquid crystal panel 1026 is diffused in a direction of 60±10 degrees with respect to the Y-axis direction. That is, under the fourth voltage application condition, a line light distribution (L4) is formed in which the incident light from the light source is diffused in a direction of 60±10 degrees with respect to the Y-axis direction.

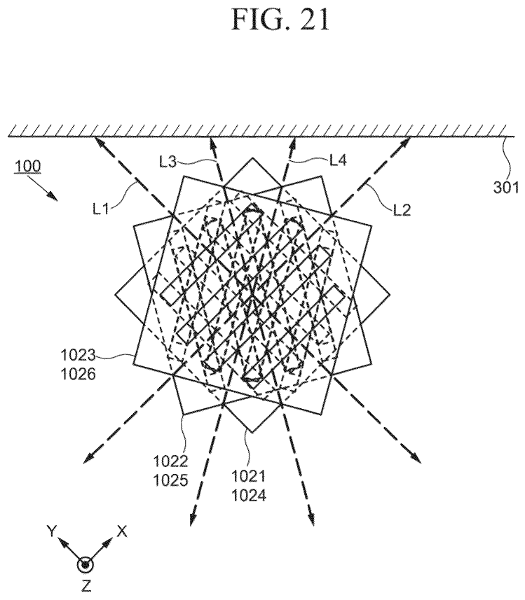

FIG. 21 shows light distribution patterns formed under the first to fourth voltage application conditions. Note that FIG. 21 shows a state in which, in the liquid crystal light control element 100 shown in FIG. 20, the first liquid crystal panel 1021 is arranged while being rotated by 45 degrees with respect to the wall surface 301. Under the first voltage application condition, a line light distribution L1 extending in the Y-axis direction is formed; under the second voltage application condition, a line light distribution L2 extending in the X-axis direction is formed; under the third voltage application condition, a line light distribution L3 extending in a direction inclined within a range of 30±10 degrees with respect to the Y-axis direction is formed; and under the fourth voltage application condition, a line light distribution L4 extending in a direction inclined within a range of 60±10 degrees with respect to the Y-axis direction is formed. These four line light distributions L1, L2, L3, and L4 are irradiated onto the wall surface 301, and since the directions in which the distributed light beams extend are different, the irradiated positions are different. In this way, by stacking and arranging liquid crystal panels in which the respective strip patterns of the first electrodes and the second electrodes intersect at an angle of 30 degrees, four-line light distributions can be formed and irradiated onto the wall surface 301. Note that the first to fourth voltage application conditions are driven for each liquid crystal panel as in the first embodiment, but the order of the voltage application conditions is arbitrary, and there is no limitation on the order in which the first to fourth voltage application conditions appear.

The lighting device 200 according to the present embodiment features a configuration in which the strip patterns of the first electrodes and the second electrodes of the liquid crystal panels constituting the liquid crystal light control element 100 are arranged to intersect at an angle of 30 degrees. With such an arrangement, line light distributions extending in four directions can be formed. With such a configuration as well, it is possible to enhance the decorative effect of an indoor space as indirect lighting.

The various configurations of the lighting device exemplified as embodiments of the present invention can be combined as appropriate as long as they are not mutually contradictory. Furthermore, any configuration appropriately modified by those skilled in the art based on the lighting device disclosed in the present specification and drawings, such as by adding, deleting, or changing the design of constituent elements, or by adding, omitting, or changing the conditions of processes, is included within the scope of the present invention as long as it encompasses the gist of the present invention.

Even regarding other advantageous effects that differ from those brought about by the aspects of the embodiments disclosed in the present specification, those that are apparent from the description in the present specification or that could be easily predicted by those skilled in the art are naturally understood to be brought about by the present invention.

What is claimed is:

1. A lighting device, comprising:
a liquid crystal light control element comprising a plurality of liquid crystal panels, wherein the plurality of liquid crystal panels is stacked, and
a housing accommodating a light source, the housing having a light emission opening and an external appearance capable of identifying a reference direction,
wherein each of the plurality of liquid crystal panels includes:
a first substrate;
a second substrate opposing the first substrate;
a liquid crystal layer between the first substrate and the second substrate;
a first strip electrode extending in a first direction and a second strip electrode arranged parallel to the first strip electrode, provided on the first substrate; and
a third strip electrode extending in a second direction intersecting the first direction and a fourth strip electrode adjacent to the third strip electrode, provided on the second substrate,
wherein the liquid crystal light control element is disposed overlapping the light emission opening, and
wherein, when the housing is arranged with the reference direction facing a wall surface, in at least one liquid crystal panel among the plurality of liquid crystal panels, an extending direction of the first strip electrode and the second strip electrode and an extending direction of the third strip electrode and the fourth strip electrode intersect a normal direction of the wall surface.

2. The lighting device according to claim 1, wherein the housing comprises a cylindrical body, wherein a part of a side surface of the cylindrical body is formed into a flat surface, and wherein the flat surface forms a reference surface identifying the reference direction.

3. The lighting device according to claim 1, wherein the housing comprises a body having a trapezoidal cross-sectional shape in a plan view, and wherein one of the side surfaces corresponding to the two parallel sides of the trapezoidal cross-sectional shape forms a reference surface identifying the reference direction.

4. The lighting device according to claim 1, wherein the housing comprises a body including a convex portion protruding from a side surface of the body, and wherein the convex portion is a marker identifying the reference direction.

5. The lighting device according to claim 1, wherein the housing comprises a body including a concave portion in a side surface of the body, and wherein the concave portion is a marker identifying the reference direction.

6. The lighting device according to claim 1, wherein the housing is provided with a marker identifying the reference direction, and wherein the marker is represented by characters, figures, or symbols.

7. The lighting device according to claim 1, wherein the plurality of liquid crystal panels includes a first liquid crystal panel, a second liquid crystal panel, a third liquid crystal panel, and a fourth liquid crystal panel, and
wherein, in each of the first to fourth liquid crystal panels, the first strip electrode and the second strip electrode are arranged to be orthogonal to the third strip electrode and the fourth strip electrode.

8. The lighting device according to claim 1, wherein the plurality of liquid crystal panels includes a first liquid crystal panel, a second liquid crystal panel, a third liquid crystal panel, and a fourth liquid crystal panel,
wherein, in each of the first to fourth liquid crystal panels, the first strip electrode and the second strip electrode are arranged to be orthogonal to the third strip electrode and the fourth strip electrode, and
wherein the third liquid crystal panel and the fourth liquid crystal panel are arranged rotated by 45 degrees with respect to the first liquid crystal panel and the second liquid crystal panel.

9. The lighting device according to claim 1, wherein the plurality of liquid crystal panels includes a first liquid crystal panel, a second liquid crystal panel, a third liquid crystal panel, a fourth liquid crystal panel, a fifth liquid crystal panel, and a sixth liquid crystal panel,
wherein, in each of the first to sixth liquid crystal panels, the first strip electrode and the second strip electrode are arranged to be orthogonal to the third strip electrode and the fourth strip electrode, and
wherein the third liquid crystal panel and the fourth liquid crystal panel are arranged rotated in a range of 30±10 degrees with respect to the first liquid crystal panel and the second liquid crystal panel, and the fifth liquid crystal panel and the sixth liquid crystal panel are arranged rotated in a range of 60±10 degrees with respect to the first liquid crystal panel and the second liquid crystal panel.

10. The lighting device according to claim 1, wherein the plurality of liquid crystal panels includes a first liquid crystal panel, a second liquid crystal panel, a third liquid crystal panel, and a fourth liquid crystal panel,
wherein, in each of the first to fourth liquid crystal panels, the first strip electrode and the second strip electrode are arranged to intersect the third strip electrode and the fourth strip electrode at an angle in a range of 45±10 degrees, and
wherein the second liquid crystal panel and the fourth liquid crystal panel are arranged rotated by 45 degrees with respect to the first liquid crystal panel and the third liquid crystal panel.

11. The lighting device according to claim 1, wherein the plurality of liquid crystal panels includes a first liquid crystal panel, a second liquid crystal panel, a third liquid crystal panel, a fourth liquid crystal panel, a fifth liquid crystal panel, and a sixth liquid crystal panel,
wherein, in each of the first to sixth liquid crystal panels, the first strip electrode and the second strip electrode are arranged to intersect the third strip electrode and the fourth strip electrode at an angle of 30±10 degrees, and
wherein the second liquid crystal panel and the fifth liquid crystal panel are arranged rotated in a range of 30±10 degrees with respect to the first liquid crystal panel and the fourth liquid crystal panel, and the third liquid crystal panel and the sixth liquid crystal panel are arranged rotated in a range of 60±10 degrees with respect to the first liquid crystal panel and the fourth liquid crystal panel.

12. The lighting device according to claim 1, wherein the liquid crystal light control element emits at least light of a first light distribution pattern extending in a first direction and light of a second light distribution pattern extending in a second direction intersecting the first direction.
